(19) United States
(12) Patent Application Publication
(10) Pub. No.: US 2024/0358055 A1
(43) Pub. Date: Oct. 31, 2024

(54) DIETARY SUPPLEMENTS FOR WEIGHT MANAGEMENT AND GLYCEMIC CONTROL

(71) Applicant: RICHARD CLARK KAUFMAN, Santa Monica, CA (US)

(72) Inventor: RICHARD CLARK KAUFMAN, Santa Monica, CA (US)

(21) Appl. No.: 18/631,934

(22) Filed: Apr. 10, 2024

Related U.S. Application Data
(60) Provisional application No. 63/496,696, filed on Apr. 18, 2023.

(51) Int. Cl. A23L 33/00; A23L 29/00; A23L 33/105; A23L 33/11; A23L 33/125

(52) U.S. Cl. CPC A23L 33/30; A23L 29/045; A23L 33/105; A23L 33/11; A23L 33/125

(57) ABSTRACT

Compositions and methods for weight loss and improved glucose control using dietary supplements and food products. Specifically, the invention pertains to the utilization of glucagon-like peptide-1 (GLP-1) agonists, inhibitors of the enzyme dipeptidyl peptidase-4 (DPP-4), and agents that improve insulin resistance in formulations comprising nutraceuticals, fibers, sweeteners, phytochemicals, botanical extracts, proteins, peptides, fatty acids, and other natural compounds. These formulations have demonstrated efficacy in facilitating weight loss, combating obesity, and improving glycemic control. The invention also encompasses various dosage forms for administering these compositions, including powders, granules, liquids, tablets, capsules, gels, and food items.

### CROSS-REFERENCE TO RELATED APPLICATIONS

This application claims priority from a U.S. Provisional Patent Appl. Ser. No. 63/496,696, filed on Apr. 18, 2023, which is incorporated herein by reference in its entirety.

### FIELD OF INVENTION

The present invention relates to food products and dietary supplements, and more particularly, the present invention relates to food products and dietary supplements that have GLP-1 agonist and a DPP-4 inhibitor for weight management and glycemic control.

### BACKGROUND

Obesity and related metabolic disorders are major health problems in modern society, which may further result in a wide range of health complications, including cardiovascular disease, diabetes, and certain types of cancer. There is a great need for effective strategies to promote weight loss and improve glucose control.

Glucagon-like peptide-1 (GLP-1) agonists are a class of compounds that mimic the effects of the incretin hormone GLP-1 or induce an endogenous release of GLP-1, which is produced and secreted by intestinal enteroendocrine L-cells and certain neurons within the nucleus of the solitary tract in the brain under food consumption. GLP-1 helps regulate and decrease blood sugar levels by stimulating insulin secretion, inhibiting glucagon secretion, and slowing gastric emptying. GLP-1 agonists produce weight loss and decrease fat accumulation by increasing the body's sensitivity to insulin, lowering blood sugar levels, and reducing appetite, feelings of hunger, and food intake, leading to a negative energy balance and weight loss. They also slow down the rate of food digestion and emptying from the stomach, prolonging the sensation of fullness, creating a feeling of satiety, reducing hunger, and reducing caloric consumption. Additionally, GLP-1 agonists can improve body composition by reducing visceral adiposity (fat stored around the organs) and increasing lean body mass.

The term “GLP-1 agonist” in the present disclosure refers to a chemical or substance that initiates a physiological response when combined with a GLP receptor. GLP-1 agonists comprise “endogenous” releasing agents and secretagogues (another name) of GLP-1 naturally produced by the body that binds to and activates GLP-1 receptors. GLP-1 agonists include “exogenous” drugs and compounds that mimic GLP-1 and create the same bodily response.

The list of GLP-1 agonists for the methods and compositions of this invention encompasses dietary fibers, phytochemicals, botanicals, fatty acids, resistant starches, sweeteners, flavonoids, alkaloids, saponins, polypeptides, terpenoids, phenolic acids, triterpenes, polyphenols, steroids, amino acids, peptides, peptide derivatives, probiotics, prebiotics, drugs, and synthetic compounds. This is not an exhaustive list, and many more classes of compounds with GLP-1 activity have yet to be discovered or studied extensively.

Some pharmaceutical GLP-agonists, referred to as GLP-1 receptor agonists (GLP-1RAs), that have been approved for use in treating obesity include liraglutide, semaglutide, and exenatide. These medications are typically administered by subcutaneous injection on a daily or weekly basis. Clinical trials have shown that treatment with GLP-1 receptor agonists can result in significant weight loss, with some patients achieving weight loss of 10% or more. GLP-1 receptor agonists currently occupy a privileged spot in the management of type-2 diabetes and obesity.

Incretin hormones are gut-derived peptide hormones, members of the glucagon superfamily, released in response to nutrient ingestion, mainly glucose and fat. They stimulate pancreatic insulin secretion in a glucose-dependent manner and play an important role in the local gastrointestinal and whole-body physiology. There are two main incretin hormones in humans: GIP (glucose-dependent insulinotropic peptide; also known as gastric inhibitory peptide) and GLP-1 (glucagon-like peptide-1). Both hormones are secreted by endocrine cells located in the epithelium of the small intestine

Dual GIP (glucose-dependent insulinotropic polypeptide)/GLP-1 receptor agonists (“twincretins”) have been recently developed, offering a new paradigm for managing Type 2 diabetes and obesity. Tirzepatide is the most recent GIP/GLP-1 receptor agonist to be used as a once-weekly subcutaneous injection.

Exogenous glucagon-like peptide-1 receptor agonists (GLP-1RAs), such as Wegovy and Ozembic, are key therapeutic agents in treating metabolic disorders. These drugs are designed to mimic the GLP-1 peptide by stimulating the GLP-1 receptor (GLP-1r), offering significant clinical benefits. A distinctive feature of these exogenous GLP-1RAs is their resistance to immediate degradation by dipeptidyl peptidase-4 (DPP-4) and elimination in the kidneys, which prolongs their biological activity.

However, despite their clinical efficacy, the real-world use of exogenous GLP-1RAs is hindered by a high discontinuation rate, with approximately 50% of patients ceasing treatment after one year and up to 70% after two years. The primary reasons for discontinuation include the gastrointestinal side effect profile (nausea, vomiting, diarrhea) and a preference for oral medication over injectables. Additionally, 13% of patients discontinue treatment due to cost concerns.

The exogenous GLP-1RAs drug has other challenges, such as being slow acting. GLP-1 RA medications produce weight loss after 8 to 12 weeks of administration. Moreover, most patients tend to regain lost weight after discontinuing GLP-1 RA medication. Moreover, approximately 50% of U.S. adults are ineligible for Semaglutide and Tripeptide-based GLP-1RA weight loss prescriptions. Research has demonstrated that endogenous plasma concentrations of GLP-1 made by the human body can be increased to levels approaching those of exogenously administered injectable GLP-1 receptor agonists by orally administered combinations of GL-1 agonist and DPP-4 inhibitor-releasing compounds.

Dipeptidyl peptidase-4 (DPP-4) is a serine dipeptidase that cleaves peptides after proline and alanine residues at their N-terminus. Inhibition of DPP-4 not only reduces the degradation of GLP-1 but also affects other peptides, including glucose-dependent insulinotropic polypeptide (GIP) and peptide YY (PYY). During DPP-4 inhibition, levels of “active GLP-1” can increase by up to 2-3 times. It is estimated that only 25% of secreted GLP-1 reaches the portal circulation, while 40-50% is metabolized in the liver, and 10-15% enters the systemic circulation for transport to the liver and brain.

DPP-4 inhibitors are a class of compounds that block the action of the enzyme dipeptidyl peptidase-4 (DPP-4), which is responsible for the degradation of incretin hormones such as GLP-1 and GIP. DPP-4 inhibitors act by preventing DPP-4-induced incretin degradation, increasing intact GLP-1 and GIP levels, and improving glucose homeostasis.

GLP-1 agonists and DPP-4 inhibitors work through different mechanisms to improve glucose control and promote weight loss. GLP-1 agonists directly stimulate the GLP-1 receptor, while DPP-4 inhibitors indirectly increase GLP-1 levels by inhibiting the degradation of the hormone.

Inhibition of DPP-4 leads to a modest increase in peripheral blood concentration of GLP-1 by a few picomoles per liter. Further inhibition of DPP-4 significantly enhances insulin secretion and reduces plasma glucose levels. This effect is accompanied by increased local intestinal and portal GLP-1 levels, which are comparable to concentrations achieved with GLP-1RAs.

Furthermore, a large population group taking a combination of orally administered endogenous GLP-1 agonists, DPP-4 inhibitors, and insulin improvers had significant weight loss after 4 weeks and reported a low incidence of adverse effects of 2%.

In addition to their glucose-lowering effects, DPP-4 inhibitors have been shown to promote weight loss. Some studies have suggested that DPP-4 inhibitors may reduce appetite and food intake, although the mechanisms underlying these effects are not yet fully understood. Other studies have suggested that DPP-4 inhibitors may increase energy expenditure and promote fat oxidation.

The list of DPP-4 inhibitor class of compounds for the methods and compositions of this invention encompasses phytochemicals, peptides, polyphenols, flavonoids, alkaloids, fatty acids, terpenoids, drugs, and synthetic compounds.

The synergy between endogenous GLP-1 agonists and DPP-4 inhibitors is particularly noteworthy. Endogenous GLP-1 agonists, unlike their exogenous pharmaceutical counterparts, are not resistant to DPP-4 degradation and do not have prolonged receptor actions. Consequently, when combined with DPP-4 inhibitors, there is a more pronounced increase in the levels of active GLP-1. This heightened presence of GLP-1 is crucial for amplifying the physiological effects on weight loss and glucose control.

Clinical trials have provided robust evidence supporting the efficacy of this combination therapy. In these studies, the dual therapy of a GLP-1 agonist and a DPP-4 inhibitor consistently outperforms monotherapy with either agent alone. Patients treated with the combination therapy exhibit greater reductions in HbA1c levels, more significant weight loss, and enhanced improvements in various markers of metabolic health.

Agonists which stimulate endogenous GLP-1 secretion were investigated alone and in combination with the DPP4 inhibitor sitagliptin in mice. These agents when orally administered individually modestly increased GLP-1 (˜5-30 pmol/L). However, combining them in oral administration synergistically elevated active endogenous GLP-1 to unprecedented concentrations (˜300-400 pmol/L). Levels approaching those of injectable exogenous GLP-1 agonist drugs.

In summary, the strategic combination of an endogenous GLP-1 agonist with a DPP-4 inhibitor can offer a promising avenue for the treatment of type 2 diabetes and obesity. This approach leverages the synergistic effects of the two agents to achieve superior outcomes in glucose control and weight management without adverse effects.

Insulin resistance is a condition in which cells become resistant to the effects of insulin, a hormone that regulates blood sugar levels. Insulin resistance leads to a reduced ability of cells to take up glucose from the bloodstream, leading to high blood sugar levels. To compensate for the reduced glucose uptake, the pancreas produces more insulin. This can lead to hyperinsulinemia, a condition in which there is too much insulin in the blood. Hyperinsulinemia is associated with various health problems, including weight gain, obesity, increased inflammation, and oxidative stress.

Insulin resistance can develop over a lifetime due to various factors such as aging processes, genetics, lifestyle, and diet. If left untreated, insulin resistance can lead to metabolic disorders such as obesity, type 2 diabetes, metabolic syndrome, and cardiovascular disease. These disorders are associated with increased risks of heart attacks, strokes, and other health complications.

The list of insulin resistance-lowering class of compounds for the methods and compositions of this invention encompasses polyphenols, omega-3 fatty acids, flavonoids, alkaloids, saponins, polypeptides, terpenoids, phenolic acids, triterpenes, steroids, peptides, and synthetic compounds.

Worldwide, studies estimate that up to 63% of pet cats and 59.3% of pet dogs are overweight or obese. Dog and cat obesity has been associated with numerous health problems, including osteoarthritis, renal disease, skin disease, insulin resistance, and neoplasia in dogs, while in cats, obesity is associated with dermatological issues, diabetes mellitus, neoplasia, and urolithiasis. The health issues appear to be slightly different across the two species.

Dogs and cats are assumed to have similar signaling mechanisms to control appetite and encompass GLP-1, leptin, ghrelin, adiponectin and PPY. Cats show obesity-related metabolic dysfunction that appears similar to metabolic syndrome in humans, whereby correction of obesity leads to improved Insulin sensitivity. In diabetic dogs, the use of drugs based on GLP-1 actions reduced blood glucose and increased glucose uptake, while in diabetic cats they reduced glycemic variability and exogenous insulin administration.

The ongoing research into GLP-1 agonists and DPP-4 inhibitors as treatments for obesity in domestic animals shows promising avenues for future veterinary applications.

However, there is a need for a suitable formulation for weight management and glycemic control that can be used as a food product or dietary supplement.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

In one aspect, disclosed are a dietary supplements and/or food products that includes glucagon-like peptide-1 (GLP-1) agonists, inhibitors of the enzyme dipeptidyl peptidase-4 (DPP-4), and compounds that improve insulin resistance and their use in facilitating weight loss, combatting obesity, and improving glycemic control.

In one aspect, disclosed are a method and composition for weight loss and glucose control and includes GLP-1 agonists, inhibitors of the enzyme DPP-4, and compounds that improve insulin resistance. The composition can be used in dietary supplements.

In one aspect, disclosed are a method and composition for reducing body weight and improving glycemic regulation. The composition includes three components, i.e., GLP-1 agonists, inhibitors of the enzyme DPP-4, and improvers of insulin resistance. The composition can be used in food products.

In one aspect, examples of GLP-1 agonists include dietary fibers, phytochemicals, botanicals, fatty acids, resistant starches, sweeteners, flavonoids, alkaloids, saponins, polypeptides, terpenoids, phenolic acids, triterpenes, polyphenols, steroids, amino acids, peptides, peptide derivatives, probiotics, prebiotics, fatty acids, and minerals.

In one aspect, the examples of GLP-1 agonists include Inulin, Oligofructose, Resistant Starch, Fatty Acids, Green Decaffeinated Coffee, Yerba Mate Extract, Berberine, Myricetin, Cinnamon, Bitter Melon, Mangosteen, Curcumin, Resveratrol, Whey Protein, Branched-Chain Amino Acids (BCAAs), Fenugreek, Green Tea, Ginseng, Psyllium, Nopal, Probiotics, Intense Sweeteners, Allulose, Stevia, Sucralose, Erythritol, Xylitol, Acesulfame Potassium.

In one aspect, the examples of the inhibitors of the enzyme DPP-4 include dietary supplements, minerals, fibers, nutraceuticals, phytochemicals, botanicals, amino acids, peptides, fatty acids, and sweeteners.

In one aspect, the examples of the inhibitors of the enzyme DPP-4 include Green Tea Extract, Whey Protein, Probiotics, Curcumin, Resveratrol, Naringenin, Kidney Bean Extract, Phenolic Compounds, Flavonoids, Blueberry/Blackberry Blends, Bitter Melon Extract, Ginseng, Gynostemma Pentaphyllum, Grape-Seed Procyanidins, Fenugreek Extract, Berberine, Polyphenols, Flavonoids, Alkaloids, Fatty Acids, and Terpenoids.

In one aspect, the one or more compounds that improve insulin resistance includes dietary supplements, minerals, fibers, nutraceuticals, phytochemicals, botanicals, amino acids, peptides, phenolic compounds, fatty acids, and sweeteners.

In one aspect, the one or more compounds that improve insulin resistance include Chromium, Naringenin, Phenolic Compounds, Pterostilbene, Fiber, Resistant starches, Resistant Dextrin, Probiotics, Green Tea Extract, Berberine, Curcumin, Cinnamon extract, Alpha-lipoic acid, Resveratrol, Quercetin, Stevia, Mangosteen, Magnesium, and Vanadium.

In one aspect, disclosed are the compositions and methods for reducing weight in individuals with insulin resistance using a dietary supplement or food product, the composition includes GLP-1 agonists, DPP-4 inhibitors, and insulin sensitivity improvers. The composition can be formulated in dosage forms, such as powders, liquids, tablets, capsules, wafers, or food products.

In one aspect, disclosed is a method for losing weight and improving insulin resistance in individuals with obesity or type 2 diabetes using dietary supplements or food products comprising GLP-1 agonists, DPP-4 inhibitors, and insulin sensitivity improvers in dosage forms such as powders, liquids, tablets, capsules, wafers, or food products.

In one aspect, disclosed is a method for reducing weight and improve glucose control in individuals with insulin resistance or type 2 diabetes using a dietary supplement or food products comprising a combination of a GLP-1 agonist, a DPP-4 inhibitor, and additional dietary supplements or nutraceuticals that improve insulin resistance in forms such as powder, liquid, tablet, capsule, wafer, or food products.

In one aspect, disclosed is a composition for reducing weight and improving glucose control in individuals with insulin resistance or type 2 diabetes comprising a dietary supplement or food comprising a combination of a GLP-1 agonist, a DPP-4 inhibitor, and additional dietary supplements or nutraceuticals that improve insulin resistance in forms such as powder, liquid, tablet, capsule, wafer, or food products.

In one aspect, disclosed is a composition for weight loss including a combination of a GLP-1 agonist and a nutraceutical inhibitor of DPP-4 activity, wherein the composition is administered in the form of a powder, liquid, capsule, tablet, wafer, or added to a food item.

In one aspect, disclosed is a method for lowering body weight, treating obesity, and improving glucose control by administering a dietary supplement or food item comprising a combination of a GLP-1 agonist and a nutraceutical, botanical extract, probiotic, prebiotic, fiber, resistant starch, protein, peptide, fatty acid, or phytochemical to a subject.

In one aspect, disclosed is a method for treating obesity and improving glucose control by administering a dietary supplement or food comprising a combination of a GLP-1 agonist and a nutraceutical, botanical extract, probiotic, prebiotic, fiber, resistant starch, protein, peptide, fatty acid, or phytochemical to a subject.

In one aspect, disclosed is a composition for weight loss comprising a combination of a GLP-1 agonist and a resistant starch, wherein the composition is administered in the form of a powder, liquid, or as an ingredient added to a food item.

In one aspect, disclosed is a method for treating metabolic syndrome by administering a dietary supplement or food item comprising a combination of a GLP-1 agonist and an inhibitor of DPP-4 activity to a subject.

In one aspect, disclosed is a composition for weight loss comprising a combination of a GLP-1 agonist, an inhibitor of the enzyme DPP-4, and an oligosaccharide, wherein the composition is administered in the form of a powder, liquid, or as an ingredient in a food item.

In one aspect, disclosed is a method and composition for treating type 2 diabetes and reducing weight by administering a dietary supplement or food item comprising a combination of a GLP-1 agonist and a phytochemical to a subject.

In one aspect, disclosed is a composition for weight loss comprising a combination of a GLP-1 agonist and a monounsaturated fatty acid, wherein the composition is administered in the form of a liquid, capsule, or added to a food item.

In one aspect, disclosed is a method for improving insulin resistance and reducing weight by administering a dietary supplement or food item comprising a combination of a GLP-1 agonist and a non-caloric sweetener to a subject.

In one aspect, disclosed is a composition for weight loss comprising a combination of a GLP-1 agonist and myricetin, wherein the composition is administered in the form of a powder, liquid, or as an ingredient in a food item.

In one aspect, disclosed is a method for reducing weight and improving glucose control by administering a dietary supplement or food item comprising a combination of a GLP-1 agonist and berberine to a subject.

In one aspect, disclosed are a method and composition for improving insulin resistance. The composition can be formulated in the form of dietary supplements and food products. The composition includes berberine, naringin, curcumin, alpha-lipoic acid, green tea extract, cinnamon, bitter melon, or resveratrol.

In one aspect, disclosed are method and composition of a dietary supplement or food product that contains resistant starch, which has been shown to improve insulin resistance by increasing the production of short-chain fatty acids in the gut.

In one aspect, disclosed is a combination therapy comprising a GLP-1 agonist and a DPP-4 inhibitor, which has been shown to improve insulin resistance and promote weight loss.

In one aspect, disclosed are methods and compositions of a dietary supplement or food item that contains monounsaturated fatty acids, such as those found in olive oil or avocado, which have been shown to improve insulin sensitivity and reduce inflammation.

In one aspect, disclosed are methods and compositions of the mineral magnesium to improve insulin resistance by enhancing glucose uptake in the muscles.

In one aspect, disclose are methods and compositions of the mineral chromium to improve insulin sensitivity and promote weight loss, encompassing forms such as chromium picolinate, chromium polynicotinate, and chromium citrate.

In one aspect, disclosed are methods and compositions of the mineral vanadium to improve insulin sensitivity, encompassing forms such as vanadyl sulfate, vanadate, vanadium amino acid chelates, vanadium citrate, vanadium picolinate, and vanadium complexed with other organic acids.

In one aspect, disclosed are methods and compositions of monounsaturated fatty acids such as those in olive oil and avocado as GLP-1 agonists, encompassing oleic acid, palmitoleic acid, or gadoleic acid.

In one aspect, disclosed are methods and compositions of fibers as GLP-1 agonists, encompassing inulin, oligofructose, pectin, beta-glucan, resistant starches, psyllium husk, guar gum, konjac glucomannan, chicory root fiber, wheat dextrin, Gellan gum, xanthan gum, cellulose derivatives (e.g., methylcellulose, carboxymethylcellulose), fructooligosaccharides, galactooligosaccharides, polydextrose, or arabinogalactan.

In one aspect, disclosed are methods and compositions of resistant starch as a GLP-1 agonist, encompassing Type 1, 2, 3, & 4, high amylose corn starch, green banana flour, cassava starch, pea starch, potato starch, Fibersol, Fibersym, Novelose, Actisar, Crystalean, or Hi-Maize.

In one aspect, disclosed are methods and compositions of resistant dextrin as a GLP-1 agonist, encompassing Nutriose, FiberWorks, Fiberest, soluble corn resistant dextrin, or tapioca fiber resistant dextrin.

In one aspect, disclosed are methods and compositions of hydrocolloids in which one substance of microscopically dispersed insoluble particles is suspended throughout another substance that comprise Xanthan Gum, Agar, Gellum Gum, Gum Arabic, Guar Gum, Locust Bean Gum, Cellulose Derivatives, Carboxymethyl Cellulose, Alginate, Pectin, Carrageenan, And Starch.

In one aspect, disclosed are methods and compositions of phytochemicals as GLP-1 agonists, encompassing resveratrol, curcumin, quercetin, luteolin, apigenin, kaempferol, catechins, epicatechins, genistein, daidzein, soy isoflavones, berberine, myricetin, naringenin, hesperetin, rutin, proanthocyanidins, ellagic acid, chlorogenic acid, ferulic acid, cinnamic acid, xanthohumol, allicin, capsaicin, gingerols, rosmarinic acid, betulinic acid, ursolic acid, oleanolic acid, betacyanins, or betaxanthins.

In one aspect, disclosed are a composition and method of phytochemicals as inhibitors of DPP-4, encompassing berberine, resveratrol, quercetin, catechins, epicatechins, curcumin, kaempferol, genistein, luteolin, apigenin, epigallocatechin gallate, resveratrol, silymarin, naringin, hesperidin, cyanidin, proanthocyanidins, anthocyanins, isoflavones, Piperine, rosmarinic acid, or ursolic acid.

In one aspect, disclosed are methods and compositions of proteins as GLP-1 agonists and inhibitors of DPP-4, encompassing whey protein isolate, whey protein concentrate, whey protein hydrolysate, or casein.

In one aspect, disclosed are method and composition of amino acids as GLP-1 agonists and inhibitors of DPP-4, encompassing glutamine, phenylalanine, arginine, and tryptophan.

In one aspect, disclosed are a composition and method of phytochemicals to improve glucose resistance, encompassing berberine, quercetin, resveratrol, curcumin, epigallocatechin gallate (EGCG), cinnamon, gymnemic acid, Astragalus membranaceus, magnolol, ginsenoside rb1, pterostilbene, naringenin, betaine, chlorogenic acid, lycopene, rutin, genistein, lutein, naringenin, ginkaempferol, oleanolic acid, ursolic acid, diosgenin, beta-sitosterol, zeaxanthin, anthocyanins, proanthocyanidins, lignans, flavonols, flavones and isoflavones, ellagitannins, ursolic acid, oleanolic acid, gymnemic acid, ginsenosides, allicin, or sulforaphane.

In one aspect, disclosed are a method and composition of intense sweeteners as GLP-1 agonists, encompassing erythritol, xylitol, tagatose, allulose, thaumatin, sucralose, luo han guo (monk fruit extract), thaumatin, or steviol glycosides.

In one aspect, disclosed are a method and composition of a GLP-1 agonist and a DPP-4 inhibitor as a dietary supplement or food item that contains a monounsaturated fatty acid, olive oil, or oleic acid.

In one aspect, disclosed are a method and composition of a GLP-1 agonist and DPP-4 inhibitor that may be administered in a variety of dosage forms, encompassing powders, capsules, tablets, gels, liquids, fluids, solid compositions, or liquids.

In one embodiment, a powder or liquid dosage form may be preferred for ease of use and/or for individuals who have difficulty swallowing pills or capsules. The powder may be dissolved in water or other liquids and consumed orally.

In one aspect, disclosed are a method and composition of a GLP-1 agonist and a DPP-4 inhibitor in a dosage form of a food item, encompassing powdered drink mixes, liquid shots, drinks, beverages, sodas, meal shakes, protein shakes, protein powders, meal bars, protein bars, wafers, candies, cookies, snack foods, or packaged food items.

In one aspect, disclosed are a method and composition of a GLP-1 agonist and a DPP-4 inhibitor manufactured as food additives.

In one aspect, disclosed are a method and composition of a GLP-1 agonist and a DPP-4 inhibitor manufactured as medicinal foods.

In one aspect, disclosed are method and composition for promoting weight loss and improving glucose control in a subject in need thereof, comprising administering to the subject a composition as described above.

In one aspect, disclosed are a method and composition for improving insulin resistance in a subject in need thereof, comprising administering to the subject a composition as described above.

In another embodiment, this invention teaches methods and compositions of endogenous GLP-1 agonists and DPP-4 inhibitors that natural glucose-dependent insulinotropic polypeptide (GIP) agonists for use as dietary supplements and in food items. Selected from a group of dietary supplements, fibers, nutraceuticals, phytochemicals, botanicals, amino acids, peptides, phenolic compounds, fatty acids, and sweeteners comprising Sucralose, Camellia sinensis Seed Saponins: The triterpene saponins from tea seeds increase GIP levels, regulate gastric emptying, and regulate gastrointestinal transit, Chlorogenic acid, Whey protein Hydrolysate: Whey protein hydrolysates and isolates increase GIP levels and prevent its degradation.

In another embodiment, this invention teaches formulations of endogenous GLP-1 agonists, DPP-4 inhibitors, and improvers of insulin resistance with a composition containing activator compounds of thermogenesis in white-and-brown adipose tissue, uncoupled protein 1 (UCP-1), converters of white adipocytes into brown adipocytes, activators of hormone-sensitive lipase causing release of fatty acids from adipose tissue, and boosters of caloric expenditures for reducing body weight. Providing synergistic actions for facilitating greater weight reduction, obesity control, and insulin utilization. A list of these activator agents that encompasses both stimulant and non-stimulant compounds comprises caffeine, capsaicin, epigallocatechin, forskolin, cinnamaldehyde, forskolin, guarana, chlorogenic acid, naringenin, fucoxanthin, cocoa beans, synephrine, piperine, yohimbine, and berberine.

Leptin, a hormone made and released from adipose tissue, signals the brain when satiety is reached. Leptin is an endogenous appetite suppressant. Obesity can cause Leptin “Resistance” similar to insulin resistance. Activation of leptin receptors (Ob-Rs) and the JAK2 complex plays a role in the pathogenesis of obesity-related diseases, increases appetite, and decreases energy expenditure.

In yet another embodiment, this invention teaches formulations of endogenous GLP-1 agonists, DPP-4 inhibitors, and improvers of insulin resistance formulated with a composition of compounds that decrease leptin resistance. Providing synergistic actions for facilitating greater weight reduction, obesity control, and insulin utilization. A list of these compounds with anti-leptin resistance actions comprises caffeine, resveratrol, cinnamaldehyde, celastrol, nuciferin, grape seed proanthocyanidins, glucoraphanin, and sulforaphane.

Ghrelin, a hormone made in the wall of the stomach fundus, plays a role in the short-term control of appetite. It signals the brain when hungry, increases food consumption, and controls blood sugar levels. The higher the level of Ghrelin, the hungrier a person becomes.

In another embodiment, this invention teaches formulations of endogenous GLP-1 agonists, DPP-4 inhibitors, and improvers of insulin resistance formulated with a composition containing suppressors of ghrelin levels for reducing body weight. A list of ghrelin suppressor compounds comprises branched-chain amino acids (leucine, isoleucine, valine), l-cysteine, and yerba mate extract.

Obesity is a state of low-grade chronic inflammation associated with the activation of the NF-κB inflammatory pathway. During obesity, adipose tissue secretes pro-inflammatory cytokines and hormones including tumor necrosis factor-α (TNF-α), interleukin-6 (IL-6), plasminogen activator inhibitor-1 (PAI-1), angiotensinogen, transforming growth factor-β (TGF-β), leptin, adiponectin, resistin, and monocyte chemoattractant protein-1 (MCP-1) that mediate cell death and inflammation within the adipose tissue, eventually resulting in lipid spill-over, glucotoxicity, and insulin resistance. Providing synergistic actions for facilitating greater weight reduction, obesity control, and insulin utilization.

In another embodiment, this invention teaches formulations of endogenous GLP-1 agonists, DPP-4 inhibitors, and improvers of insulin resistance formulated with a composition containing phytochemical, nutraceutical, fatty acid, and botanical anti-inflammatory compounds. A list of anti-inflammatory compounds comprises naringenin, resveratrol, quercetin, pomegranate extract, curcuminoids, epigallocatechin-3-gallate, green tea extract, tea extract, olive oil, capsaicin, ginger extract, and black seed extract. Providing synergistic actions for facilitating greater weight reduction, obesity control, and insulin utilization.

α-Amylase is a digestive enzyme secreted by the pancreas and salivary glands. Natural α-amylase inhibitors can lower post-prandial hyperglycemia by delaying the breakdown of carbohydrates and reducing the absorption of glucose. Reducing post-prandial hyperglycemia inhibits the formation and storage of triacylglycerol by preventing glucose absorption into adipose tissue.

Alpha-glucosidase inhibitors are antihyperglycemic agents that lower blood glucose by delaying the digestion and absorption of complex carbohydrates. They are competitive inhibitors of the enzymes in the brush border of enterocytes that cleave oligosaccharides to monosaccharides.

Collectively α-amylase and alpha-glucosidase inhibitors are referred to as carbohydrate blockers.

In another embodiment, this invention teaches formulations of endogenous GLP-1 agonists, DPP-4 inhibitors, and improvers of insulin resistance formulated with a composition containing phytochemical, nutraceutical, fatty acid, and natural α-amylase and alpha-glucosidase inhibitor compounds. A list of natural α-amylase and α-glucosidase inhibitors comprises Phaseolus vulgaris (kidney bean extract, Prosopis cineraria extract, Terfezia claveryi extract, quercetin, cyanidin, baicalein, lupeol, isoquercetin, Chenopodium album extract, Centaurea iberica extract, Cichorium endivia extract, ferulic acid, raspberry leaf tea extract, rosmaric acid, epigallocatechin gallate (EGCG), ellagic acid, cinnamon extract, garlic oil extract, onion oil extract, mulberry extract, Chinese bayberry leaf-derived proanthocyanidins, chlorogenic acid, Punica granatum extract, Andrographis echioides extract, agave americana, luteolin, and Salvia lavandulifolia extract. Providing synergistic actions for facilitating greater weight reduction, obesity control, and insulin utilization.

Pancreatic lipase enzyme is a key enzyme for the digestion of dietary triglycerides, and fats. Inhibition of pancreas lipase has prevented the absorption of approximately 30% of dietary fats via gastrointestinal mechanisms.

In another embodiment, this invention teaches formulations of endogenous GLP-1 agonists, DPP-4 inhibitors, and improvers of insulin resistance formulated with a composition containing natural plant extract and phytochemical pancreas lipase inhibitor compounds. A list of natural pancreas lipase inhibitors comprises caffeine, theophylline, theobromine, kaempferol, fucoxanthin, galangin, luteolin, 7-phloroeckol, extract of peanut shell, EGCG, grape seed extract, dioscin. diosgenin, and chitosan Morinda citrifolia extract, Momordica charantia extract, Illicium religiosum extract, jniperus communis extract, Nelumbo nucifera extract, Prunella vulgaris extract, Rheum palmatum extract, Eleusine indica extract, pomegranate extract, grape seed extract, mango leaf and bark extract, and Centella asiatica extract. Providing synergistic actions for facilitating greater weight reduction, obesity control, and insulin utilization

In another embodiment, this invention teaches formulations of endogenous GLP-1 agonists, DDP-4 inhibitors, and improvers of insulin resistance co-administered (at the same time) in a different dosage form composition structure than the above-mentioned composition structures that are comprised of thermogenesis activator compounds, leptin resistance improvers, ghrelin suppressors, lipase inhibitors, regulators of adipocyte differentiation, alpha-amylase inhibitors, releasors of cholecystokinin (CCK), stimulators of β-adrenergic receptors, activators of adenosine monophosphate-activated protein kinase (AMPK), mono-and-dual amylin and calcitonin receptor agonists, and anti-inflammatory agents. Providing synergistic actions for facilitating greater weight reduction, obesity control, and insulin utilization.

In another embodiment, this invention teaches formulations of endogenous GLP-1 agonists, DDP-4 inhibitors, and improvers of insulin resistance co-administered (at the same time) with different weight reduction classes of compounds and controllers of obesity-signaling pathways that include Insulin/IRS Pathway, Adipokine Signaling, Sirtuin1-AMPK Pathway, Sirtuin1-AMPK Pathway, Inflammatory Pathways, PPARs, Wnt/β-catenin, Hedgehog, PKG Signaling, Gut Hormones, TGF-β/SMAD3, β3-adrenergic signaling, and Ob-R/JAK2 complex. Providing synergistic actions for facilitating greater weight reduction, obesity control, and insulin utilization.

In another embodiment, this invention teaches formulations of endogenous GLP-1 agonists, DDP-4 inhibitors, and improvers of insulin resistance co-administered (at the same time) in a different dosage form composition structure than the above-mentioned weight reduction classes of compounds and controllers of obesity-signaling pathways. A list of dosage forms for co-administration comprises powders, granules, liquids, tablets, capsules, gels, food items, emulsions, and nano-dimensional structures.

In another embodiment, this invention teaches formulations of endogenous GLP-1 agonists and DPP-4 inhibitors formulated to treat obesity in dogs, cats, and other animals.

In another embodiment, this invention teaches formulations of endogenous GLP-1 agonists and DPP-4 inhibitors formulated to treat overweight dogs, cats, and other animals.

### DETAILED DESCRIPTION

The subject matter will now be described more fully hereinafter. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

The following detailed descriptions of the formulations provide tables of the preferred ingredients and amounts as well as supplemental beneficial ingredients. Those of ordinary skill in the art will recognize the following abbreviations used throughout this detailed description: “g” refers to grams, “mg” refers to milligrams, “mcg” refers to micrograms, “oz.” refers to ounces, and “ml” refers to milliliters.

Inulin: A type of soluble fiber found in many plants, including chicory root, Jerusalem artichoke, and asparagus. In animal and human studies, inulin has been shown to increase GLP-1 levels and improve glucose tolerance. Inulin is commonly used as a prebiotic to promote the growth of beneficial gut bacteria.

Oligofructose: A type of fructooligosaccharide found in many fruits and vegetables. In animal and human studies, oligofructose has been shown to increase GLP-1 levels and improve glucose tolerance. Oligofructose is commonly used as a prebiotic to promote the growth of beneficial gut bacteria.

Resistant Starch: A non-fermentable, soluble dietary fermentable fiber and starch that resists digestion in the small intestine has been shown to stimulate the release of GLP-1, decrease body fat accumulation, and improve glucose tolerance. Resistant starches facilitate weight loss in humans by reshaping the gut microbiota. Inducing changes in the gut microbiota able to reduce lipid absorption.

Fatty Acids: Monounsaturated long-chain fatty acids are potent stimulators of GLP-1 release. They include Oleic Acid (18:1) found in high concentrations in olive oil. That is consumed as part of a Mediterranean Diet.

Green Decaffeinated Coffee: Contains chlorogenic acid that lowers the glycemic index of meals and increases GLP-1.

Yerba Mate Extract: South American botanical drink that increases GLP-1 levels.

Berberine: A compound found in several plants, including goldenseal and barberry. In animal studies, berberine has been shown to improve insulin sensitivity and reduce body weight by increasing GLP-1 levels.

Myricetin: A flavonoid found in many types of fruit and vegetables. In animal studies, myricetin has been shown to improve glucose metabolism and reduce body weight by increasing GLP-1 levels.

Cinnamon: A spice commonly used in cooking. In animal and human studies, cinnamon has been shown to improve glucose metabolism and reduce body weight by increasing GLP-1 levels.

Bitter Melon: Some fruit commonly used in traditional medicine to treat diabetes. In animal and human studies, bitter melon has been shown to improve glucose metabolism and reduce body weight by increasing GLP-1 levels.

Mangosteen: A tropical fruit that has been shown to improve glucose metabolism and reduce body weight by increasing GLP-1 levels in animal studies.

Curcumin: Curcumin is a phytochemical found in turmeric that has been found to have GLP-1 agonist activity and help improve insulin sensitivity.

Resveratrol: A phytochemical found in grapes, red wine, and peanuts that has been found to have GLP-1 agonist activity and improve insulin sensitivity.

Whey Protein: Whey protein, available in the forms of concentrate, isolate, and hydrolysate, has been shown to increase GLP-1 secretion, delay gastric emptying, and suppress appetite.

Branched-Chain Amino Acids (BCAAs): Essential amino acids found in high-protein foods such as meat, dairy, and legumes that have been found to stimulate GLP-1 secretion and may help with weight loss and glucose control.

Fenugreek: A botanical that contains saponins that have been found to stimulate GLP-1 secretion and may aid in glucose control.

Green Tea: A botanical that contains catechins has been found to stimulate GLP-1 secretion and may aid in weight loss and glucose control.

Ginseng: A botanical that contains ginsenosides which have been found to stimulate GLP-1 secretion and may aid in glucose control.

Psyllium: A soluble fiber supplement that has been found to stimulate GLP-1 secretion and may aid in glucose control and weight loss.

Nopal: A cactus plant that contains fiber and betalains which have been found to stimulate GLP-1 secretion and may aid in glucose control and weight loss.

Probiotics: Beneficial bacteria found in fermented foods and supplements have been found to stimulate GLP-1 secretion and may aid in glucose control and weight loss.

Intense Sweeteners: Highly diverse substances either of plant origin or obtained by chemical synthesis that have a sweetening power tens to thousands of times greater than sucrose and contain few or no calories, have demonstrated significant GLP-1 agonist activity. Examples include erythritol, xylitol, tagatose, allulose, sucralose or steviol glycosides.

Allulose: D-allulose is a rare sugar with practically zero calories that stimulates endogenous GLP-1 secretion. Allulose has significantly reduced body mass index (BMI), abdominal fat, and subcutaneous fat areas.

Stevia: Rebaudioside A from Stevia rebaudiana stimulates GLP-1 release by enteroendocrine cells via bitter taste signaling pathways in animal studies.

Sucralose: A synthetic sweetener that is commonly used in many low-calorie or sugar-free products. Research has shown that sucralose can increase GLP-1 secretion in healthy human subjects.

Erythritol: Erythritol is a sugar alcohol that is commonly used as a low-calorie sweetener. Studies have shown that erythritol can increase GLP-1 release and improve glucose metabolism.

Xylitol: Xylitol is a sugar alcohol that has been shown to have GLP-1 agonist activity in animal studies.

Acesulfame Potassium: Acesulfame potassium is an artificial sweetener that has been shown to stimulate GLP-1 release in animal studies.

Green Tea Extract: Green tea contains catechins, which have been shown to inhibit DPP-4 activity, improve insulin sensitivity, and promote weight loss.

Whey Protein: Whey protein, available in the forms of concentrate, isolate, and hydrolysate, has been shown to inhibit the activity of DPP-IV in research studies.

Probiotics: Certain strains of live bacteria and yeasts that inhibit DPP-4 activity and improve insulin sensitivity.

Curcumin: Curcumin, in addition to its effects on weight loss and insulin sensitivity, has also been shown to inhibit DPP-4 activity. This may help improve glucose control and reduce the risk of diabetes.

Resveratrol: Resveratrol, in addition to its effects on weight loss and insulin sensitivity, has also been shown to inhibit DPP-4 activity. This may help improve glucose control and reduce the risk of diabetes.

Naringenin: A flavonoid glycoside belonging to flavanones subclass has decreased insulin resistance, inhibited DDP-4, and increased glucose uptake. Naringin activated the thermogenic protein UCP1 for weight loss via the AMPK signaling pathway.

Kidney Bean Extract: Protein fractions derived from kidney beans were found to inhibit DPP-4 activity by 96.7%.

Phenolic Compounds: The flavonoids luteolin, apigenin, and flavone found in berries and citrus have demonstrated significant DPP-4 inhibition.

Flavonoids: Derived from fruits and vegetables, the flavonoids Cyanidin 3-O-glucoside, anthocyanins, emodin, rutin, isoquercetin, cirsimaritin, hispidulin, naringenin, quercetin, galangin, kaempferol, vitexin, and rutin have demonstrated DPP-4 inhibition.

Blueberry/Blackberry Blends: DPP-4 activity was potently inhibited by anthocyanins isolated from blueberry/blackberry blends.

Bitter Melon Extract: Bitter melon, also known as Momordica charantia, is a fruit that has traditionally been used in Ayurvedic and Chinese medicine to treat diabetes. Some studies have shown that bitter melon may inhibit DPP-4 activity, which may help improve glucose control.

Ginseng: Ginseng is an herb that has been used in traditional Chinese medicine for centuries. Some studies have shown that ginseng may inhibit DPP-4 activity and improve glucose control in people with type 2 diabetes.

Gynostemma Pentaphyllum: Also known as jiaogulan, this herb has been used in traditional Chinese medicine. Some studies have suggested that Gynostemma pentaphyllum may inhibit DPP-4 activity and improve glucose control.

Grape-Seed Procyanidins: Derived from Vitis vinifera, GSP inhibits DPP-4 and increases GLP-1 levels.

Fenugreek Extract: An herb that may inhibit DPP-4 activity and improve glucose control.

Berberine: A phytochemical found in several plants that can inhibit DPP-4 activity and improve glucose control in people with type 2 diabetes.

Polyphenols: These are natural compounds found in plants that have been shown to inhibit DPP-4 activity. Examples include resveratrol, quercetin, and epigallocatechin gallate (EGCG).

Flavonoids: These are a class of polyphenolic compounds that have been shown to inhibit DPP-4 activity. Examples include apigenin, luteolin, and naringenin.

Alkaloids: These naturally occurring compounds can inhibit DPP-4 activity. Examples include berberine, palmatine, and magnoflorine.

Fatty Acids: Certain types of fatty acids, such as linoleic acid and stearic acid, have been shown to inhibit DPP-4 activity.

Terpenoids: These are a large class of natural compounds that have diverse biological activities, including inhibition of DPP-4. Examples include oleanolic acid, ursolic acid, and betulinic acid.

Chromium: A mineral that plays a role in insulin signaling and glucose metabolism. Studies have shown that chromium supplementation may improve insulin sensitivity and promote weight loss in individuals with type 2 diabetes.

Naringenin: A flavonoid belonging to flavanones subclass has decreased insulin resistance, inhibited DDP-4, and increased glucose uptake. Naringin activated the thermogenic protein UCP1 for weight loss via the AMPK signaling pathway.

Phenolic Compounds: The flavonoids luteolin, apigenin, and flavone, and the stilbenoid resveratrol significantly decrease insulin resistance.

Pterostilbene: A phenolic compound derived from resveratrol that improves insulin resistance in part by reducing Advanced Glycation End Products (AGEs).

Fiber: Fiber, found in fruits, vegetables, whole grains, and legumes, has been shown to improve insulin sensitivity and promote weight loss. Fiber can help regulate blood sugar levels and reduce appetite by promoting feelings of fullness.

Resistant Starch: Resistant starches are well documented to improve insulin sensitivity in healthy and obese volunteers as well as in patients with metabolic syndrome,

Resistant Dextrin: Resistant dextrin has been shown to improve insulin resistance, oxidative stress and inflammatory Biomarkers

Probiotics: Certain strains of beneficial bacteria found in fermented foods and supplements have been shown to improve insulin sensitivity and promote weight loss. Probiotics may help reduce inflammation and improve gut health, which can contribute to improved insulin sensitivity.

Green Tea Extract: Green tea extract contains compounds called catechins, which have been shown to improve insulin sensitivity and promote weight loss. Green tea extract may also help reduce appetite and increase metabolism.

Berberine: A phytochemical found in several plants that has been shown to improve insulin sensitivity and promote weight loss in individuals with type 2 diabetes.

Curcumin: A compound found in turmeric, a spice commonly used in Indian cuisine. Studies have shown that curcumin supplementation may improve insulin sensitivity and promote weight loss by reducing inflammation and oxidative stress.

Cinnamon Extract: Cinnamon extract contains compounds called cinnamaldehyde and cinnamic acid, which have been shown to improve insulin sensitivity and promote weight loss.

Alpha-Lipoic Acid: Alpha-lipoic acid is an antioxidant that has been shown to improve insulin sensitivity and promote weight loss in overweight and obese individuals. Alpha-lipoic acid may also help reduce inflammation and improve blood sugar control.

Resveratrol: A phytochemical compound found in grapes, red wine, and several plants. Studies have shown that resveratrol supplementation may improve insulin sensitivity and promote weight loss by reducing inflammation and improving lipid metabolism.

Quercetin: A flavonoid found in various fruits and vegetables. Studies have shown that quercetin may improve insulin sensitivity by reducing inflammation, oxidative stress, and lipid accumulation in cells.

Stevia: Rebaudioside A from Stevia rebaudiana helps improve insulin sensitivity

Mangosteen: A tropical fruit that has been shown to improve insulin sensitivity and reduce body weight in animal studies.

Magnesium: Magnesium has been shown to improve insulin resistance by enhancing glucose uptake in the muscles.

Vanadium: A trace mineral that has been shown to improve insulin, mimic the effects of insulin, and enhance the uptake of glucose into cells, thus lowering blood sugar levels.

Fiber: Fiber, found in fruits, vegetables, whole grains, and legumes, has been shown to improve insulin sensitivity and promote weight loss. Fiber can help regulate blood sugar levels and reduce appetite by promoting feelings of fullness.

Resistant Starch: Resistant starches are well documented to improve insulin sensitivity in healthy and obese volunteers as well as in patients with metabolic syndrome,

Resistant Dextrin: Resistant dextrin has been shown to improve insulin resistance, oxidative stress, and inflammatory Biomarkers

Probiotics: Certain strains of beneficial bacteria found in fermented foods and supplements have been shown to improve insulin sensitivity and promote weight loss. Probiotics may help reduce inflammation and improve gut health, which can contribute to improved insulin sensitivity.

Green Tea Extract: Green tea extract contains compounds called catechins, which have been shown to improve insulin sensitivity and promote weight loss. Green tea extract may also help reduce appetite and increase metabolism.

Berberine: A phytochemical found in several plants that has been shown to improve insulin sensitivity and promote weight loss in individuals with type 2 diabetes.

Curcumin: A compound found in turmeric; a spice commonly used in Indian cuisine. Studies have shown that curcumin supplementation may improve insulin sensitivity and promote weight loss by reducing inflammation and oxidative stress.

Cinnamon Extract: Cinnamon extract contains compounds called cinnamaldehyde and cinnamic acid, which have been shown to improve insulin sensitivity and promote weight loss.

Alpha-Lipoic Acid: Alpha-lipoic acid is an antioxidant that has been shown to improve insulin sensitivity and promote weight loss in overweight and obese individuals. Alpha-lipoic acid may also help reduce inflammation and improve blood sugar control.

Resveratrol: A phytochemical compound found in grapes, red wine, and several plants. Studies have shown that resveratrol supplementation may improve insulin sensitivity and promote weight loss by reducing inflammation and improving lipid metabolism.

Quercetin: A flavonoid found in various fruits and vegetables. Studies have shown that quercetin may improve insulin sensitivity by reducing inflammation, oxidative stress, and lipid accumulation in cells.

Stevia: Rebaudioside A from Stevia rebaudiana helps improve insulin sensitivity

Mangosteen: A tropical fruit that has been shown to improve insulin sensitivity and reduce body weight in animal studies.

Magnesium: Magnesium has been shown to improve insulin resistance by enhancing glucose uptake in the muscles.

Vanadium: A trace mineral that has been shown to improve insulin, mimic the effects of insulin, and enhance the uptake of glucose into cells, thus lowering blood sugar levels.

Disclosed are the food products and dietary supplements that help humans and animals to combat obesity and improve glycemic control. Also disclosed is a composition for use in food products and dietary supplements, wherein the composition includes GLP-1 agonists, DPP-4 enzyme inhibitors, and Insulin Resistance Improvers. The composition has a synergistic combination of GLP-1 agonists, DPP-4 enzyme inhibitors, and Insulin Resistance Improvers that help both humans and animals to combat obesity, control weight, and improve glycemic control. The disclosed composition can be used in formulations and dosage forms, such as the food products and dietary supplements. The formulations and dosage forms may include other ingredients, such as carbohydrates, amino acids, Vitamins, and the like, and any ingredient known to a person of ordinary skills in the art for use in the food products and dietary supplements is within the scope of the present invention. Suitable preservatives, such as benzoic acid, butylated hydroxy anisol (BHA), butylated hydroxyl toluene (BHT), tert-butylhydroquinone (TBHQ), vinegar, citric acid, calcium propionate, and the like. Similarly, the formation and dosage form may include emulsifiers, such as soy, lecithin, polysorbates, and the like. Although it is preferable that the ingredients used in the disclosed formulations and dosage forms are natural, however, the use of any synthetic and semi-synthetic ingredients are within the scope of the present invention. For example, various artificial colorants and flavors are commonly used in food products and supplements, and any such ingredients are within the scope of the present invention.

In certain implementations, the disclosed composition may further include GIP agonist in combination with the GLP-1 agonists, DPP-4 enzyme inhibitors, and agents that enhance insulin sensitivity. Table 1 shows examples of GLP-1 agonists, DPP-4 enzyme inhibitors, insulin sensitivity improvers, and GIP agonist. Table 1 also shows the quantity of respective ingredients, how this range can be modified without departing from the scope of the present invention.

The dosage range for GLP-1 agonists, DPP-4 enzyme inhibitors, agents that enhance insulin sensitivity, and GIP agonists in the disclosed composition can be manipulated based on variety of factors, such as age of user. Formulations of the present invention may include dosages beyond the preferred ranges specified for the active components listed in Table 1, as well as incorporate ingredients and compounds not mentioned in Table 1, while remaining within the invention's scope and essence. These ingredients are used in formulating the examples of dietary supplements and food items of this invention that comprise food additives, drink mix powders, liquid shots, nutritional bars, meal replacement shakes, protein powders, non-caloric sweeteners, fiber blends, snack foods, frozen desserts, and functional beverages for facilitating weight loss, combatting obesity, and improving glycemic control.

TABLE 1
List of ingredients:

| Ingredient | Daily Dosage | |
|---|---|---|
| Glucagon-like peptide-1 (GLP-1) Agonists | | |
| Inulin | 4-12 | g |
| Oligofructose | 5-20 | g |
| Resistant Starch | 2-15 | g |
| Whey Protein Isolate/Hydrolysate | 5-25 | g |
| Monounsaturated fatty acids | 5-25 | g |
| Chlorogenic acid (green decaffeinated coffee) | 100-500 | mg |
| Berberine | 1-5 | g |
| Myricetin | 50-220 | mg |
| Cinnamon bark extract | 0.5-2 | g |
| Bitter Melon Extract | 1-5 | g |
| Mangosteen Extract | 0.3-1.2 | g |
| Curcuminoid extract (95%) | 0.75-2 | g |
| Resveratrol | 100-500 | mg |
| Branched-chain amino acids (BCAAs) | 3-20 | g |
| Fenugreek seed extract | 1-4 | g |
| Epigallocatechin (Green tea extract) | 200-1000 | mg |
| Panax ginseng extract | 0.5-2 | g |
| Psyllium Husk | 0.5-20 | g |
| Nopal cactus extract | 1-4 | g |
| Probiotics | 10-20 billion | CFU |
| Allulose | 5-25 | g |
| Stevia (Rebaudioside A) | 0.4-1.5 | g |
| Sucralose | 200-800 | mg |
| Erythritol | 25-75 | g |
| Xylitol | 20-65 | g |
| Dipeptidyl peptidase-4 (DPP-4) Inhibitors | | |
| Whey Protein Isolate/Hydrolysate | 5-25 | g |
| Probiotics | 10-20 billion | CFU |
| Curcuminoid extract (95%) | 750-2000 | mg |
| Resveratrol | 100-500 | mg |
| Naringenin | 300-1200 | mg |
| Blueberry/blackberry anthocyanins | 0.5-2.5 | g |
| Grape-seed procyanidins | 0.2-2 | g |
| Luteolin | 100-500 | mg |
| Apigenin | 500-2500 | mg |
| Bitter melon extract | 1-5 | g |
| Panax ginseng extract | 0.5-2 | g |
| Gynostemma pentaphyllum extract | 0.5-3 | g |
| Fenugreek seed extract | 1-4 | g |
| Berberine | 1-5 | g |
| Quercetin | 250-1000 | mg |
| Epigallocatechin (green tea extract) | 200-1000 | mg |
| Conjugated Linoleic Acid | 2.5-10 | g |
| Ursolic acid | 250-900 | mg |
| Betulinic Acid | 100-400 | mg |
| Insulin Resistance Improvers | | |
| Chromium (picolinate, chelate, nicotinate) | 100-500 | mcg |
| Naringenin | 300-1200 | mg |
| Luteolin | 100-500 | mg |
| Apigenin | 500-2500 | mg |
| Resveratrol | 100-500 | mg |
| Pterostilbene | 200-1000 | mg |
| Resistant Starch | 10-40 | g |
| Resistant Dextrin | 10-20 | g |
| Probiotics | 10-20 billion | CFU |
| Epigallocatechin (green tea extract) | 200-1000 | mg |
| Rebaudioside A (stevia) | 0.4-1.2 | g |
| Berberine | 1-5 | g |
| Curcuminoid extract (95%) | 750-2000 | mg |
| Cinnamon bark extract | 0.5-2 | g |
| R-lipoic acid | 0.2-1 | g |
| Quercetin | 250-1000 | mg |
| Mangosteen Extract | 0.3-1.2 | g |
| Magnesium (glycinate or citrate) | 0.2-1 | g |
| Vanadium (vanadyl sulfate) | 50-200 | mg |
| Glucose-dependent insulinotropic | | |
| polypeptide (GIP) agonists | | |
| Sucralose | 200-800 | mg |
| Camellia sinensis Seed Saponins | 225-800 | mg |
| Chlorogenic acid | 100-500 | mg |
| Whey protein Hydrolysate | 15-45 | g |

### Formula 1

The present invention encompasses a Low-Carb, Sugar-Free, Aqueous-Soluble, Multi-Product Use formulation comprising phytochemicals, botanical extracts, probiotics, sweeteners, and resistant starches and minerals within the field of natural products and nutrition science. The formula is designed for facilitating weight loss, combatting obesity, and improving glycemic control as a dietary supplement or incorporated into food items. The composition comprises glucagon-like peptide-1 (GLP-1) agonists, dipeptidyl peptidase-4 (DPP-4) inhibitors, and compounds that improve insulin resistance.

TABLE 2
List of ingredients of Formula 1

| Ingredient | Daily Amount per Unit Dose | |
|---|---|---|
| Allulose | 5-15 | g |
| Inulin | 2-10 | g |
| Resistant Starch | 10-30 | g |
| Berberine HCl | 1-3 | g |
| Myricetin | 50-220 | mg |
| Mulberry Leaf Polyphenols | 300-900 | mg |
| Camellia sinensis Seed Saponins | 225-800 | mg |
| Resveratrol | 100-300 | mg |
| Quercetin | 275-750 | mg |
| R-Lipoic Acid | 200-800 | mg |
| Blueberry/Blackberry Anthocyanins | 0.5-2 | g |
| Chromium Picolinate | 150-450 | mcg |
| Vanadyl Sulfate | 50-150 | mg |
| Naringin | 200-800 | mg |

### Formula 2

The present invention encompasses a Low-Carb, Sugar-Free, Aqueous-Soluble, Flavored Drink Mix formulation comprising non-caloric sweeteners phytochemicals, botanical extracts, probiotics, and resistant starches within the field of natural products and nutrition science. The formula is designed for facilitating weight loss, combatting obesity, and improving glycemic control as a dietary supplement or incorporated into food items. The composition comprises glucagon-like peptide-1 (GLP-1) agonists, dipeptidyl peptidase-4 (DPP-4) inhibitors, and compounds that improve insulin resistance.

TABLE 3
List of ingredients of Formula 2

| Ingredient | Daily Amount per Unit Dose | |
|---|---|---|
| Allulose | 5-15 | g |
| Inulin | 2-10 | g |
| Resistant Starch | 10-30 | g |
| Berberine HCl | 1-3 | g |
| Myricetin | 50-220 | mg |
| Mulberry Leaf Polyphenols | 300-900 | mg |
| Mangosteen Extract | 300-900 | mg |
| Resveratrol | 100-300 | mg |
| Quercetin | 275-750 | mg |
| R-Lipoic Acid | 200-800 | mg |
| Blueberry/Blackberry Anthocyanins | 0.5-2 | g |
| Chromium Picolinate | 150-450 | mcg |
| Vanadyl Sulfate | 50-150 | mg |
| Naringin | 200-800 | mg |
| Sucralose | 200-800 | mg |
| Camellia sinensis Saponins | 250-800 | mg |
| Chlorogenic Acid | 200-500 | mg |

### Formula 3

The present invention encompasses a Low-Carb, Sugar-Free, Aqueous-Soluble Thermogenic Fat-Burner formulation comprising phytochemicals, botanical extracts, probiotics, non-caloric sweeteners, and resistant starches in the field of natural products and nutrition science. The formula is designed for facilitating weight loss, combatting obesity, and improving glycemic control as a dietary supplement or incorporated into food items. The composition comprises glucagon-like peptide-1 (GLP-1) agonists, dipeptidyl peptidase-4 (DPP-4) inhibitors, and compounds that improve insulin resistance. This formulation includes a composition of thermogenic activator compounds of uncoupled protein 1 (UCP-1) in white and brown adipose tissue for activating fat loss. Providing synergistic actions for facilitating greater weight reduction, obesity control, and insulin utilization.

TABLE 4
List of ingredients of Formula 3

| Ingredient | Daily Amount per Unit Dose | |
|---|---|---|
| Allulose | 5-15 | g |
| Inulin | 4-12 | g |
| Resistant Starch | 10-30 | g |
| Berberine HCl | 1-3 | g |
| Myricetin | 50-220 | mg |
| Mulberry Leaf Polyphenols | 300-900 | mg |
| Mangosteen Extract | 300-900 | mg |
| Resveratrol | 100-300 | mg |
| Quercetin | 275-750 | mg |
| Blueberry/Blackberry Anthocyanins | 0.5-2 | g |
| R-Lipoic Acid | 200-800 | mg |
| Chromium Picolinate | 150-450 | mcg |
| Naringin | 300-900 | mg |
| Fucoxanthin (Seaweed) | 20-80 | mg |
| Forskolin | 25-100 | mg |
| Chlorogenic Acid | 100-400 | mg |
| Epigallocatechin | 200-800 | mg |

### Formula 4

The present invention encompasses a Low-Carb Sugar-Free, Aqueous-Soluble Thermogenic Fat-Burner formulation comprising phytochemicals, botanical extracts, probiotics, non-caloric sweeteners, and resistant starches within the field of natural products and nutrition science. The formula is designed for facilitating weight loss, combatting obesity, and improving glycemic control as a dietary supplement or incorporated into food items. The composition comprises glucagon-like peptide-1 (GLP-1) agonists, dipeptidyl peptidase-4 (DPP-4) inhibitors, and compounds that improve insulin resistance. This formulation includes a composition of thermogenic activator compounds of uncoupled protein 1 (UCP-1) in white and brown adipose tissue for activating fat loss. Providing synergistic actions for facilitating greater weight reduction, obesity control, and insulin utilization. Formula 4 contains more stimulant type of thermogenic activator compounds compared to Formula 3.

TABLE 5
List of ingredients of Formula 4

| Ingredient | Daily Amount per Unit Dose | |
|---|---|---|
| Allulose | 5-15 | g |
| Inulin | 4-12 | g |
| Resistant Starch | 10-30 | g |
| Berberine HCl | 1-3 | g |
| Blueberry/Blackberry Anthocyanins | 0.5-2 | g |
| Myricetin | 50-220 | mg |
| Mulberry Leaf Polyphenols | 300-900 | mg |
| Mangosteen Extract | 300-900 | mg |
| Resveratrol | 100-300 | mg |
| Quercetin | 275-750 | mg |
| R-Lipoic Acid | 200-800 | mg |
| Chromium Picolinate | 150-450 | mcg |
| Naringin | 300-900 | mg |
| Fucoxanthin (Seaweed) | 20-80 | mg |
| Forskolin | 25-100 | mg |
| Chlorogenic Acid | 100-400 | mg |
| Epigallocatechin | 200-800 | mg |
| Cocoa Bean Extract | 1-2 | g |
| Caffeine | 40-200 | mg |
| Synephrine | 25-100 | mg |
| Yohimbine | 5-25 | mg |
| Rebaudioside A (stevia) | 0.4-1 | g |

| | |
|---|---|
| Natural Flavor | AR |

### Formula 5

The present invention encompasses an Aqueous-Soluble, Sugar-free, Prebiotic and Fiber Powdered Drink Mix formulation comprising phytochemicals, botanical extracts, probiotics, non-caloric sweeteners, minerals, and resistant starches within the field of natural products and nutrition science. The formula is designed for facilitating weight loss, combatting obesity, and improving glycemic control. The composition comprises glucagon-like peptide-1 (GLP-1) agonists, dipeptidyl peptidase-4 (DPP-4) inhibitors, and compounds that improve insulin resistance. The daily amount is consumed in two divided doses and is formulated to be mixed with water or another beverage.

TABLE 6
List of ingredients of Formula 5

| Ingredient | Daily Amount | |
|---|---|---|
| Allulose | 4-12 | g |
| Inulin | 4-12 | g |
| Resistant Starch | 10-30 | g |
| Berberine HCl | 1-3 | g |
| Myricetin | 50-220 | mg |
| Mulberry Leaf Polyphenols | 300-900 | mg |
| Resveratrol | 100-300 | mg |
| Quercetin | 275-750 | mg |
| R-Lipoic Acid | 200-800 | mg |
| Blueberry/Blackberry Anthocyanins | 0.5-2 | g |
| Chromium Picolinate | 150-450 | mcg |
| Naringin | 300-900 | mg |
| Rebaudioside A (stevia) | 0.4-1 | g |

| | |
|---|---|
| Natural Flavor | AR |
| Natural Color | AR |

### Formula 6

The present invention encompasses a Whey Protein Powder Shake with BCAAs formulation comprising fibers, phytochemicals, probiotics botanical extracts, and non-caloric sweeteners. vitamins and minerals within the field of natural products and nutrition science. The formula is designed for facilitating weight loss, combatting obesity, and improving glycemic control. The composition comprises glucagon-like peptide-1 (GLP-1) agonists, dipeptidyl peptidase-4 (DPP-4) inhibitors, glucose-dependent insulinotropic polypeptide (GIP) agonists, and compounds that improve insulin resistance. The composition is formulated to be mixed with water or another beverage and consumed in two divided doses before meals.

TABLE 7
List of ingredients of Formula 6

| Ingredient | Daily Amount | |
|---|---|---|
| Whey Protein (hydrolysate/isolates) | 15-30 | g |
| Branched-chain amino acids (BCAAs) | 4-12 | g |
| Soluble Corn Fiber/Resistant Starch | 10-30 | g |
| Inulin | 4-12 | g |
| Cinnamon Bark Extract | 0.5-1.5 | g |
| Resveratrol | 100-300 | mg |
| Blueberry/Blackberry Anthocyanins | 0.5-2 | g |
| Mulberry Leaf Extract | 300-900 | mg |
| Chlorogenic Acid | 100-300 | mg |
| Allulose | 15-20 | g |
| Sucralose | 400-1000 | mg |
| MCT Oil Powder | 2-6 | g |
| High Oleic Sunflower Oil | 1.5-3.5 | g |
| Olive Oil | 5-10 | g |
| Natural Flavor | AR | |
| Natural Color | AR | |
| Vitamin A (as vitamin A palmitate) | 750 | mcg |
| Vitamin C (as ascorbic acid) | 60 | mg |
| Vitamin D (as ergocalciferol) | 50 | mcg |
| Vitamin E (as d-alpha tocopherol acetate) | 10 | mg |
| Vitamin B1 (as thiamin hydrochloride) | 0.75 | mg |
| Vitamin B2 (as riboflavin) | 0.85 | mg |
| Vitamin B3 (as niacinamide) | 10 | mg |
| Vitamin B6 (as pyridoxine hydrochloride) | 1 | mg |
| Folate (as calcium L-5 tetrahydrofolate) | 333 | mcg |
| Vitamin B12 (as methylcobalamin) | 200 | mcg |
| D-Biotin | 200 | mcg |
| Pantothenic Acid (as calcium d-pantothenate) | 5 | mg |
| Iron (as naturally occurring) | 5.40 | mg |
| Phosphorus (as tricalcium phosphate & | 500 | mg |
| naturally occurring) | | |
| Iodine (as potassium iodide) | 75 | mcg |
| Magnesium (as magnesium glycinate) | 400 | mg |
| Calcium (as calcium citrate) | 400 | mg |
| Zinc (as zinc citrate) | 20 | mg |
| Selenium (as selenium chelate) | 35 | mcg |
| Copper (as copper amino acid chelate) | 2 | mg |
| Manganese (as manganese citrate) | 0.90 | mg |
| Chromium (as Polynicotinate) | 200 | mcg |
| Molybdenum (as naturally occurring) | 90 | mcg |
| Chloride (as sodium chloride) | 300 | mg |
| Sodium (as sodium chloride) | 400 | mg |
| Potassium (as naturally occurring) | 260 | mg |
| Probiotic Blend | 50 | mg |

| | |
|---|---|
| Natural Flavor | AR |
| Natural Color | AR |

### Formula 7

The present invention encompasses a Complete Meal Replacement formulation comprising proteins, BCAAs, resistant starch, soluble fibers, botanical extracts, phytochemicals, fatty acids, non-caloric sweeteners, vitamins, minerals, adaptogens, medicinal mushrooms, green foods, vegetables, and probiotics within the field of natural products and nutrition science. The formula is designed for facilitating weight loss, combatting obesity, and improving glycemic control. The composition comprises glucagon-like peptide-1 (GLP-1) agonists, dipeptidyl peptidase-4 (DPP-4) inhibitors, glucose-dependent insulinotropic polypeptide (GIP) agonists, and compounds that improve insulin resistance. The composition is formulated to be mixed with water or another beverage and consumed in two divided doses before meals.

TABLE 8
List of ingredients of Formula 7

| Ingredient | Daily Amount | |
|---|---|---|
| Whey Protein (hydrolysate/isolates) | 10-30 | g |
| Branched-chain amino acids (BCAAs) | 4-12 | g |
| Soluble Corn Fiber/Resistant Starch | 10-30 | g |
| Inulin | 4-12 | g |
| Cinnamon Bark Extract | 0.5-1.5 | g |
| Resveratrol | 100-300 | mg |
| Blueberry/Blackberry Anthocyanins | 0.5-2 | g |
| Mulberry Leaf Extract | 300-900 | mg |
| Chlorogenic Acid | 100-300 | mg |
| Allulose | 15-20 | g |
| Sucralose | 200-750 | mg |
| MCT Oil Powder | 2-4 | g |
| High Oleic Sunflower Oil | 1.5-3 | g |
| Olive Oil | 2.5-5 | g |
| Black Currant Seed Oil | 1 | g |
| Evening Primrose Oil | 1 | g |
| Vitamin A (as vitamin A palmitate) | 750 | mcg |
| Vitamin C (as ascorbic acid) | 60 | mg |
| Vitamin D (as ergocalciferol) | 50 | mcg |
| Vitamin E (as d-alpha tocopherol acetate) | 10 | mg |
| Vitamin B1 (as thiamin hydrochloride) | 0.75 | mg |
| Vitamin B2 (as riboflavin) | 0.85 | mg |
| Vitamin B3 (as niacinamide) | 10 | mg |
| Vitamin B6 (as pyridoxine hydrochloride) | 1 | mg |
| Folate | 333 | mcg |
| Vitamin B12 (as cyanocobalamin) | 3 | mcg |
| Biotin | 75 | mcg |
| Pantothenic Acid (as calcium d-pantothenate) | 5 | mg |
| Calcium (as citrate & naturally occurring) | 400 | mg |
| Iodine (from kelp) | 150 | mcg |
| Phosphorus (as tricalcium phosphate) | 500 | mg |
| Magnesium (as magnesium glycinate & naturally occurring) | 400 | mg |
| Zinc (as zinc citrate) | 20 | mg |
| Selenium (as selenate) | 50 | mcg |
| Copper (as copper amino acid chelate) | 2 | mg |
| Manganese (as manganese citrate & naturally occurring) | 0.90 | mg |
| Chromium (as polynicotinate) | 100 | mcg |
| Molybdenum (as naturally occurring) | 90 | mcg |
| Chloride (as sodium chloride and naturally occurring) | 300 | mg |
| Sodium (as sodium chloride and naturally occurring) | 400 | mg |
| Potassium (as naturally occurring) | 200-400 | mg |
| Fiber Blend - Whole Grain Oat, Organic Acacia Gum, | 5-10 | g |
| Chia, Flax | | |
| Antioxidant/Super-Fruit Blend- Acai Berry Extract Powder, | 1 | g |
| Red Wine Powder Extract (Vitis vinifera), Grape Seed | | |
| Powder Extract (Vitis vinifera), Biberry Powder Extract, | | |
| Green Tea Extract, Olive Leaf Extract Powder, Maqui Berry, | | |
| Camu-Camu Berry, Blackberry, Raspberry | | |
| Adaptogen Blend: Maca Root, Shiitake Mushroom Mycelia, | 1 | g |
| Maitake Mushroom Mycelia, Reishi Mushroom Mycelia, | | |
| Cordyceps Mushroom Mycelia, Rhodioa rosea | | |
| Phytochemical/Greens/Vegetable Blend: Lycopene, Lutein, | 1 | g |
| Astaxanthin, Zeaxanthin, Beet, Carrot, Spinach, Broccoli, | | |
| Tomato, Kale, Parsley Leaf, Brussels Sprouts, Green Pepper, | | |
| Celery, Garlic, Chlorella | | |
| Probiotic Blend | 50 | mg |
| Piperine | 10 | mg |
| Rebaudoside A (stevia) | 0.4-1 | g |

| | |
|---|---|
| Natural Flavor | AR |
| Natural Color | AR |

### Formula 8

The present invention encompasses a Concentrated Liquid Shot Drink comprising phytochemicals, non-caloric sweeteners, soluble fibers, and probiotics within the field of natural products and nutrition science. The formula is designed for facilitating weight loss, combatting obesity, and improving glycemic control. The composition comprises glucagon-like peptide-1 (GLP-1) agonists, dipeptidyl peptidase-4 (DPP-4) inhibitors, glucose-dependent insulinotropic polypeptide (GIP) agonists, and compounds that improve insulin resistance. The daily amount is consumed in two divided doses.

TABLE 9
List of ingredients of Formula 8

| Ingredient | Daily Amount | |
|---|---|---|
| Allulose | 5-15 | g |
| Inulin | 4-12 | g |
| Resistant Starch | 10-30 | g |
| Myricetin | 50-220 | mg |
| Mulberry Leaf Polyphenols | 300-900 | mg |
| Resveratrol | 100-300 | mg |
| Quercetin | 225-675 | mg |
| R-Lipoic Acid | 250-750 | mg |
| Blueberry/Blackberry Anthocyanins | 0.5-2 | g |
| Chromium Picolinate | 150-450 | mcg |
| Naringin | 300-900 | mg |
| Sucralose | 200-800 | mg |
| Natural Flavor | As required (AR) | |
| Natural Color | AR | |
| Water (Carrier) | 50-75 | ml |

### Formula 9

The present invention encompasses a Hydrocolloid Weight Loss Gel formulation within the field of natural products and nutrition science comprising phytochemicals, botanical extracts, non-caloric sweeteners, soluble fibers, and probiotics. The formula is designed for facilitating weight loss, combatting obesity, and improving glycemic control. The composition comprises glucagon-like peptide-1 (GLP-1) agonists, dipeptidyl peptidase-4 (DPP-4) inhibitors, glucose-dependent insulinotropic polypeptide (GIP) agonists, and compounds that improve insulin resistance. The daily amount is consumed in two divided doses.

TABLE 10
List of ingredients of Formula 9

| Ingredient | Daily Amount | |
|---|---|---|
| Allulose | 5-15 | g |
| Inulin | 3-12 | g |
| Resistant Starch | 10-15 | g |
| Xanthan Gum | 0.2%-1% of the total | |
| | liquid weight | |
| Myricetin | 50-220 | mg |
| Mulberry Leaf Polyphenols | 300-900 | mg |
| Resveratrol | 100-300 | mg |
| Quercetin | 225-675 | mg |
| R-Lipoic Acid | 250-750 | mg |
| Blueberry/Blackberry Anthocyanins | 0.5-2 | g |
| Chromium Picolinate | 150-450 | mcg |
| Naringin | 300-900 | mg |
| Sucralose | 200-800 | mg |
| Natural Flavor | As required (AR) | |
| Natural Color | AR | |
| Water | 50-80 | ml |

### Formula 10

The present invention encompasses a Hydrocolloid Weight Loss Gel formulation within the field of natural products and nutrition science comprising phytochemicals, botanical extracts, non-caloric sweeteners, soluble fibers, and probiotics. The formula is designed for facilitating weight loss, combatting obesity, and improving glycemic control. The composition comprises glucagon-like peptide-1 (GLP-1) agonists, dipeptidyl peptidase-4 (DPP-4) inhibitors, glucose-dependent insulinotropic polypeptide (GIP) agonists, and compounds that improve insulin resistance. The daily amount is consumed in two divided doses.

TABLE 11
List of ingredients of Formula 10

| Ingredient | Daily Amount | |
|---|---|---|
| Allulose | 5-15 | g |
| Inulin | 3-12 | g |
| Resistant Starch | 10-15 | g |
| Xanthan Gum | 0.2-1% of the total | |
| | liquid weight | |
| Myricetin | 50-220 | mg |
| Mulberry Leaf Polyphenols | 300-900 | mg |
| Resveratrol | 100-300 | mg |
| Quercetin | 225-675 | mg |
| R-Lipoic Acid | 250-750 | mg |
| Blueberry/Blackberry Anthocyanins | 0.5-2 | g |
| Chromium Picolinate | 150-450 | mcg |
| Naringin | 300-900 | mg |
| Sucralose | 200-800 | mg |
| Natural Flavor | As required (AR) | |
| Natural Color | AR | |
| Water | 50-80 | ml |

### Formula 11

The present invention encompasses a Nootropic, Weight Loss, and Energy Hydrocolloid Gel formulation within the field of natural products and nutrition science comprising phytochemicals, botanical extracts, non-caloric sweeteners, soluble fibers, and probiotics. The formula is designed for facilitating weight loss, combatting obesity, and improving glycemic control. The composition comprises glucagon-like peptide-1 (GLP-1) agonists, dipeptidyl peptidase-4 (DPP-4) inhibitors, glucose-dependent insulinotropic polypeptide (GIP) agonists, and compounds that improve insulin resistance. The daily amount is consumed in two divided doses.

TABLE 12
List of ingredients of Formula 11

| Ingredient | Daily Amount | |
|---|---|---|
| Allulose | 5-15 | g |
| Inulin | 3-12 | g |
| Resistant Starch | 10-14 | g |
| Xanthan Gum | 0.2-1% of the total | |
| | liquid weight | |
| Mulberry Leaf Polyphenols | 300-600 | mg |
| Resveratrol | 100-300 | mg |
| Quercetin | 225-675 | mg |
| Caffeine | 50-100 | mg |
| Vinpocetine | 15-60 | mg |
| Noopept | 10-40 | mg |
| Caffeine | 50-100 | mg |
| Citicoline | 200-400 | mcg |
| Huperzine A | 200-800 | mcg |
| Blueberry/Blackberry Anthocyanins | 0.5-1.5 | g |
| Chromium Picolinate | 150-450 | mcg |
| Naringin | 300-900 | mg |
| Sucralose | 200-800 | mg |
| Natural Flavor | As required (AR) | |
| Natural Color | AR | |
| Water | 50-80 | ml |

### Formula 12

The present invention encompasses a Concentrated Liquid Shot Emulsion Drink within the field of natural products and nutrition science comprising phytochemicals, botanical extracts, non-caloric sweeteners, soluble fibers, MCTs, and probiotics. The formula is designed for facilitating weight loss, combatting obesity, and improving glycemic control. The composition comprises glucagon-like peptide-1 (GLP-1) agonists, dipeptidyl peptidase-4 (DPP-4) inhibitors, glucose-dependent insulinotropic polypeptide (GIP) agonists, and compounds that improve insulin resistance. The daily amount is consumed in two divided doses. May be modified by adding the energy and nootropic compounds in formula 10.

TABLE 13
List of ingredients of Formula 12

| Ingredient | Daily Amount | |
|---|---|---|
| Allulose | 5-15 | g |
| Inulin | 4-12 | g |
| Resistant Starch | 10-30 | g |
| Myricetin | 50-220 | mg |
| Mulberry Leaf Polyphenols | 300-900 | mg |
| Resveratrol | 100-300 | mg |
| Quercetin | 225-675 | mg |
| R-Lipoic Acid | 250-750 | mg |
| Blueberry/Blackberry Anthocyanins | 0.5-2 | g |
| Chromium Picolinate | 150-450 | mcg |
| Naringin | 300-900 | mg |
| Sucralose | 200-800 | mg |
| Natural Flavor | As required (AR) | |
| Natural Color | AR | |
| Water (Carrier) | 50-75 | ml |

| | |
|---|---|
| MCTs (Medium Chain Triglycerides) | 0.5-2.0% (w/w) |
| Polysorbate 20 or 80 | 0.1-0.5% (w/w) |

### Formula 13

The present invention encompasses a Sugar-Free, High-Protein Fiber Bar in the field of natural products and nutrition science comprising proteins, non-caloric sweeteners, soluble fibers, MCTs, and probiotics. The formula is designed for facilitating weight loss, combatting obesity, and improving glycemic control, The composition comprises glucagon-like peptide-1 (GLP-1) agonists, dipeptidyl peptidase-4 (DPP-4) inhibitors, glucose-dependent insulinotropic polypeptide (GIP) agonists, and compounds that improve insulin resistance. The daily amount is consumed in two divided doses.

TABLE 14
List of ingredients of Formula 13

| Ingredient | Daily Amount (One Bar) | |
|---|---|---|
| Whey protein (hydrolysates/isolates) | 20-25 | g |
| Resistant starch | 10-20 | g |
| Allulose | 8-15 | g |
| Inulin | 4-12 | g |
| Cocoa beans | 8-14 | g |
| Sucralose | 2-3 | g |
| Water or almond milk | 30-40 | ml |
| Optional: flavorings | To taste | |
| Optional: Coating | | |
| Sugar-Free Dark Chocolate | 5-20 | g |
| MCT/Coconut/Vegetable Oil | 3-10 | g |

### Formula 14

The present invention encompasses a Sugar-Free, Low-Carb, High-Protein, High-Fiber Chocolate Cluster Snack formulation in the field of natural products and nutrition science comprising proteins, non-caloric sweeteners, soluble fibers, MCTs, and probiotics. The formula is designed for facilitating weight loss, combatting obesity, and improving glycemic control, The composition comprises glucagon-like peptide-1 (GLP-1) agonists, dipeptidyl peptidase-4 (DPP-4) inhibitors, glucose-dependent insulinotropic polypeptide (GIP) agonists, and compounds that improve insulin resistance. The daily amount is consumed in two divided doses.

TABLE 15
List of ingredients of Formula 14

| Ingredient | Daily Amount (4 clusters) | |
|---|---|---|
| Whey protein (hydrolysates/isolates) | 5-15 | g |
| Resistant starch | 8-14 | g |
| Allulose | 8-14 | g |
| Inulin | 4-10 | g |
| MCT/Coconut Oil | 3-10 | g |
| Cocoa beans | 4-12 | g |
| Organic Cocoa Powder | 1-2 | g |
| Nut Oil | 1.5-5 | g |
| Optional Nuts and Seeds | 1.5-5 | g |
| Coating | | |
| Sugar-Free Dark Chocolate | 5-15 | g |
| MCT/Coconut/Vegetable Oil | 1-3 | g |
| Cocoa Butter | 1-3 | g |
| Erythritol | 2-5 | g |
| Safflower Lecithin | 0.5-1 | g |
| Natural Creme Flavor | 0.1-0.5 | g |
| Vanilla Flavor | 0.1-0.5 | g |

### Formula 15

The present invention encompasses a High-Protein, Sugar-Free, Prebiotic Fiber Bar Formulation within the field of natural products and nutrition science comprising proteins, non-caloric sweeteners, soluble fibers, and probiotics. The formula is designed for facilitating weight loss, combatting obesity, and improving glycemic control. The composition comprises glucagon-like peptide-1 (GLP-1) agonists, dipeptidyl peptidase-4 (DPP-4) inhibitors, glucose-dependent insulinotropic polypeptide (GIP) agonists, and compounds that improve insulin resistance. The daily amount is consumed in two divided doses.

TABLE 16
List of ingredients of Formula 15

| Ingredient | Daily Amount (One Bar) | |
|---|---|---|
| Whey protein (hydrolysates/isolates) | 14-20 | g |
| Resistant starch | 10-25 | g |
| Allulose | 10-15 | g |
| Sucralose | 0.5-1.5 | g |
| Inulin | 4-12 | g |
| Almond Flour | 7-9 | g |
| Coconut Flour | 3 | g |
| Baking Powder | 0.5 | g |
| Almond Flour | 9-12 | g |
| Eggs | 2 | g |
| Vanilla Extract | 0.4 | g |

| | |
|---|---|
| Natural Flavor | AR |

### Formula 16

The present invention encompasses a Low-Calorie, Sugar-Free, High-Fiber Gummy Containing Phytochemicals within the field of natural products and nutrition science comprising phytochemicals, botanical extracts, non-caloric sweeteners, soluble fibers, pectin, minerals, and probiotics. The formula is designed for facilitating weight loss, combatting obesity, and improving glycemic control. The composition comprises glucagon-like peptide-1 (GLP-1) agonists, dipeptidyl peptidase-4 (DPP-4) inhibitors, and compounds that improve insulin resistance. The daily amount is consumed in two divided doses. May be modified by adding the energy and nootropic compounds in formula 10.

TABLE 17
List of ingredients of Formula 16

| Ingredient | Daily Amount (4 gummies) | |
|---|---|---|
| Allulose | 5-15 | g |
| Inulin | 4-12 | g |
| Resistant Starch | 3-9 | g |
| Mulberry Leaf Polyphenols | 300-900 | mg |
| Blueberry/Blackberry Anthocyanins | 0.5-2 | g |
| Chromium Picolinate | 150-250 | mcg |
| Naringin | 300-900 | mg |
| Sucralose | 200-800 | mg |
| Pectin | 1.5-3 | g |
| Natural Color | 0.1 | g |
| Natural Fruit Extract Flavor | 2-4 | g |
| Water | 15-25 | g |
| Citric Acid | 0.2 | g |

### Formula 17

The present invention encompasses a High-Fiber, Prebiotic Powder Mix formulation within the field of natural products and nutrition science comprising phytochemicals, non-caloric sweeteners, soluble fibers, resistant starch, resistant dextrin, and probiotics. The formula is designed for facilitating weight loss, combatting obesity, and improving glycemic control. The composition comprises glucagon-like peptide-1 (GLP-1) agonists, dipeptidyl peptidase-4 (DPP-4) inhibitors, and compounds that improve insulin resistance.

TABLE 18
List of ingredients of Formula 17

| Ingredient | Daily Amount | |
|---|---|---|
| Resistant Starch | 15-30 | g |
| Resistant Dextrin | 10-20 | g |
| Fructooligosaccharides | 3-10 | g |
| Inulin | 4-12 | g |
| Allulose | 5-15 | g |
| Blueberry/Blackberry Anthocyanins | 0.5-2 | g |

| | |
|---|---|
| Natural Flavor | AR |

### Formula 18

The present invention encompasses an Antioxidant, Prebiotic, and Sugar-Free Soda formulation within the field of natural products and nutrition science comprising phytochemicals, non-caloric sweeteners, MCTs, and probiotics. The formula is designed for facilitating weight loss, combatting obesity, and improving glycemic control. The composition comprises glucagon-like peptide-1 (GLP-1) agonists, dipeptidyl peptidase-4 (DPP-4) inhibitors, and compounds that improve insulin resistance.

TABLE 19
List of ingredients of Formula 18

| Ingredient | Daily Amount | |
|---|---|---|
| Carbonated Water | 355 | ml |
| Inulin | 4-12 | g |
| Allulose | 8-10 | g |
| Rebaudioside A (stevia) | 0.4-1 | g |
| Berry Flavor Extract | 0.2-0.5 | ml* |
| Grape Flavor Extract | 0.2-0.5 | ml* |
| Apple Flavor Extract | 0.2-0.5 | ml* |
| Citric Acid | 0.05-0.1 | g |
| Naringin | 100-300 | mg |
| Blueberry/Blackberry Anthocyanins | 0.5-2 | g |
| Mulberry Leaf Polyphenols | 100-200 | mg |
| Resveratrol | 75-150 | mg |
| Quercetin | 100-200 | mg |

| | |
|---|---|
| Natural Color (Optional) | AR |

### Formula 19

The present invention encompasses a Sugar-Free, Antioxidant, Energy Soda formulation within the field of natural products and nutrition science comprising phytochemicals, botanical extracts, non-caloric sweeteners, thermogenic compounds, natural stimulants, and probiotics. The formula is designed for facilitating weight loss, combatting obesity, and improving glycemic control. The composition comprises glucagon-like peptide-1 (GLP-1) agonists, dipeptidyl peptidase-4 (DPP-4) inhibitors, glucose-dependent insulinotropic polypeptide (GIP) agonists, and compounds that improve insulin resistance. This formulation includes a composition of thermogenic activator compounds of uncoupled protein 1 (UCP-1) in white and brown adipose tissue for activating fat loss. Providing synergistic actions for facilitating greater weight reduction, obesity control, and insulin utilization. May be modified by adding the energy nootropic compounds in formula 10.

TABLE 20
List of ingredients of Formula 19

| Ingredient | Daily Amount | |
|---|---|---|
| Carbonated Water | 355 | ml |
| Inulin | 4-12 | g |
| Allulose | 8-10 | g |
| Rebaudioside A (stevia) | 0.4-1 | g |
| Berry Flavor Extract | 0.2-0.5 | ml* |
| Grape Flavor Extract | 0.2-0.5 | ml* |
| Apple Flavor Extract | 0.2-0.5 | ml* |
| Citric Acid | 0.05-0.1 | g |
| Naringin | 100-300 | mg |
| Blueberry/Blackberry Anthocyanins | 0.5-2 | g |
| Mulberry Leaf Polyphenols | 100-200 | mg |
| Resveratrol | 75-150 | mg |
| Quercetin | 100-200 | mg |
| Fucoxanthin (Seaweed) | 20-80 | mg |
| Caffeine | 60-150 | mg |
| Forskolin | 25-75 | mg |
| Chlorogenic Acid | 100-300 | mg |
| Epigallocatechin | 200-400 | mg |
| Cocoa Bean Extract | 1-2 | g |

| | |
|---|---|
| Natural Color (Optional) | AR |

Formula 20

### Formula 20

The present invention encompasses a Sugar-Free, High-Protein, Low-Calorie, Prebiotic, Fruit-Flavored Smoothie formulation within the field of natural products and nutrition science comprising proteins, phytochemicals, botanical extracts, non-caloric sweeteners, soluble fibers, vitamins, minerals, hydrocolloids, probiotics. The formula is designed for facilitating weight loss, combatting obesity, and improving glycemic control. The composition comprises glucagon-like peptide-1 (GLP-1) agonists, dipeptidyl peptidase-4 (DPP-4) inhibitors, glucose-dependent insulinotropic polypeptide (GIP) agonists, and compounds that improve insulin resistance.

TABLE 21
List of ingredients of Formula 20

| Ingredient | Daily Amount | |
|---|---|---|
| Whey Protein Isolate | 15-25 | g |
| Allulose | 8-12 | g |
| Inulin | 4-12 | g |
| Resistant Starch | 10-30 | g |
| Resveratrol | 75-150 | mg |
| Quercetin | 100-200 | mg |
| Naringin | 100-300 | mg |
| Mulberry Polyphenols | 100-200 | mg |
| Blueberry/Blackberry Anthocyanins | 0.5-2 | g |
| Citric Acid | 0.5 | g |
| Xanthan Gum | 0.3 | g |
| Gum Arabic | 0.2 | g |
| Soy Lecithin | 0.5 | g |
| Sucralose | 200-800 | mg |
| Carrageenan | 0.2 | g |
| Calcium (Citrate) | 200 | mg |
| Potassium (Phosphate) | 100 | mg |
| Potassium (Citrate) | 100 | mg |
| Magnesium (citrate) | 50 | mg |
| Ascorbic Acid | 60 | mg |
| Zinc (Citrate) | 15 | mg |
| Natural Vitamin E | 60 | IU |
| Niacinamide | 20 | mg |
| Calcium Pantothenate | 10 | mg |
| Manganese | 2 | mg |
| Copper | 1 | mg |
| Pyridoxine Hydrochloride | 2 | mg |
| Riboflavin | 1.7 | mg |
| Thiamin Mononitrate | 1.5 | mg |
| Vitamin A Palmitate | 2500 | IU |
| Chromium Chloride | 120 | mcg |
| Folic Acid | 400 | mcg |
| Biotin | 300 | mcg |
| Potassium Iodide | 150 | mcg |
| Sodium Molybdate | 75 | mcg |
| Sodium Selenate | 70 | mcg |
| Vitamin K1 | 80 | mcg |
| Vitamin D3 | 400 | IU |
| Vitamin B12 | 6 | mcg |

| | |
|---|---|
| Natural Fruit Flavors | To Taste |

Formula 21

### Formula 21

The present invention encompasses a Natural Non-Caloric, Prebiotic, Sugar-Free, Sweetener Blend formulation in powder or granule form developed within the field of natural products and nutrition science comprising phytochemicals, non-caloric sweeteners, soluble fibers, resistant starches, and probiotics. The formula is designed for facilitating weight loss, combatting obesity, and improving glycemic control as a food item or incorporated into food items. The composition comprises glucagon-like peptide-1 (GLP-1) agonists, dipeptidyl peptidase-4 (DPP-4) inhibitors, and compounds that improve insulin resistance.

TABLE 22
List of ingredients of Formula 21

| Ingredient | Daily Amount (Two Tablespoons) | |
|---|---|---|
| Allulose | 5-15 | g |
| Stevia (Rebaudioside A) | 1-3 | g |
| Resistant Starch | 15-20 | g |
| Inulin | 4-12 | g |
| Grape-seed procyanidins | 0.4-1.2 | g |

Formula 22

### Formula 22

The present invention encompasses a Prebiotic, Phytochemical, Non-Caloric, Sugar-Free, Sweetener Blend formulation in powder or granule form developed within the field of natural products and nutrition science comprising phytochemicals, non-caloric sweeteners, soluble fibers, resistant starches, and probiotics. The formula is designed for facilitating weight loss, combatting obesity, and improving glycemic control as a food item or incorporated into food items. The composition comprises glucagon-like peptide-1 (GLP-1) agonists, dipeptidyl peptidase-4 (DPP-4) inhibitors, glucose-dependent insulinotropic polypeptide (GIP) agonists, and compounds that improve insulin resistance.

TABLE 23
List of ingredients of Formula 22

| Ingredient | Daily Amount | |
|---|---|---|
| Sucralose | 400-800 | mg |
| Allulose | 5-15 | g |
| Resistant Starch | 15-20 | g |
| Inulin | 4-12 | g |
| Blueberry/Blackberry Anthocyanins | 0.4-1.2 | g |

Formula 23

### Formula 23

The present invention encompasses a Weight Loss, Leptin-Resistance Decreasing, High-Fiber Sugar-Free formulation comprising phytochemicals, botanical extracts, non-caloric sweeteners, soluble fibers, and probiotics within the field of natural products and nutrition science. The formula is designed for facilitating weight loss, combatting obesity, and improving glycemic control as a dietary supplement, food item, or incorporated into food items. The composition comprises glucagon-like peptide-1 (GLP-1) agonists, dipeptidyl peptidase-4 (DPP-4) inhibitors, glucose-dependent insulinotropic polypeptide (GIP) agonists, and compounds that improve insulin resistance. This formulation includes a composition for decreasing leptin resistance. Providing synergistic actions for facilitating greater weight reduction, obesity control, and insulin utilization.

TABLE 24
List of ingredients of Formula 23

| Ingredient | Daily Amount per Unit Dose | |
|---|---|---|
| Allulose | 5-15 | g |
| Inulin | 3-9 | g |
| Resistant Starch | 10-30 | g |
| Berberine HCl | 1-3 | g |
| Myricetin | 50-220 | mg |
| Mulberry Leaf Polyphenols | 300-900 | mg |
| Mangosteen Extract | 300-900 | mg |
| Resveratrol | 100-300 | mg |
| Quercetin | 275-750 | mg |
| R-Lipoic Acid | 200-800 | mg |
| Chromium Picolinate | 150-450 | mcg |
| Naringin | 300-900 | mg |
| Blueberry/Blackberry Anthocyanins | 1-2.5 | g |
| Grape Seed Proanthocyanidins | 0.2-2 | g |
| Sulforaphane | 1-9 | mg |

Formula 24

### Formula 24

The present invention encompasses a Weight Loss, Ghrelin-lowering, High-Fiber, Sugar-Free formulation comprising phytochemicals, botanical extracts, non-caloric sweeteners, soluble fibers, probiotics, BCAAs, and minerals formulation within the field of natural products and nutrition science. The formula is designed for facilitating weight loss, combatting obesity, and improving glycemic control as a food item or incorporated into food items. The composition comprises glucagon-like peptide-1 (GLP-1) agonists, dipeptidyl peptidase-4 (DPP-4) inhibitors, and compounds that improve insulin resistance. This formulation includes a composition for decreasing leptin resistance. This formulation includes a composition of ghrelin-lowering compounds for decreasing hunger and reducing body weight. Providing synergistic actions for facilitating greater weight reduction, obesity control, and insulin utilization.

TABLE 25
List of ingredients of Formula 24

| Ingredient | Daily Amount per Unit Dose | |
|---|---|---|
| Allulose | 5-15 | g |
| Inulin | 4-12 | g |
| Resistant Starch | 8-15 | g |
| Berberine HCl | 1-3 | g |
| Myricetin | 50-220 | mg |
| Mulberry Leaf Polyphenols | 300-900 | mg |
| Mangosteen Extract | 300-900 | mg |
| Resveratrol | 100-300 | mg |
| Quercetin | 275-750 | mg |
| R or Alpha Lipoic Acid | 200-800 | mg |
| Chromium Picolinate | 150-450 | mcg |
| Naringin | 300-900 | mg |
| Branched-Chain Amino Acids (Leucine, Isoleucine, | 4-15 | g |
| Valine) | | |
| L-Cysteine | 2-8 | g |
| Yerba Mate Extract | 100-400 | mg |

Formula 25

### Formula 25

The present invention encompasses A Low-Calorie Soft-Serve, Sugar-Free, Frozen Dessert formulation within the field of natural products comprising proteins, fibers, prebiotics, non-caloric sweeteners, probiotics, phytochemicals, hydrocolloids, and botanical extracts within the field of natural products and nutrition science. The formula is designed for facilitating weight loss, combatting obesity, and improving glycemic control. The composition comprises glucagon-like peptide-1 (GLP-1) agonists, dipeptidyl peptidase-4 (DPP-4) inhibitors, glucose-dependent insulinotropic polypeptide (GIP) agonists, and compounds that improve insulin resistance.

TABLE 26
List of ingredients of Formula 25

| Ingredient | Daily Amount Per Dose | |
|---|---|---|
| Water | 40-50 | g |
| Whey protein (hydrolysate/isolates) | 15-25 | g |
| Allulose | 5-15 | g |
| Inulin | 4-12 | g |
| Resistant Starch (maltodextrin)_{—} | 10-20 | g |
| Blueberry/Blackberry Anthocyanins | 1-2.5 | g |
| Cocoa Bean Extract | 0.5-1.5 | g |
| Cellulose Gum | 300 | mm |
| Xanthan Gum | 200 | mg |
| Carrageenan | 100 | mg |
| Flavor | 1 | g |
| Probiotic Culture Blend | 10-20 | billion CFU |
| Sucralose | 0.4-1 | g |

Formula 26

### Formula 26

The present invention encompasses a Fat-and-Carbohydrate Blocker, Weight Loss formulation comprising phytochemicals, botanical extracts, probiotics, and non-caloric sweeteners. The formula is designed for facilitating weight loss, combatting obesity, and improving glycemic control as a dietary supplement or incorporated into food items. The composition comprises glucagon-like peptide-1 (GLP-1) agonists, dipeptidyl peptidase-4 (DPP-4) inhibitors, and compounds that improve insulin resistance. This formulation includes a composition of natural α-amylase inhibitors, α-glucosidase inhibitors, and pancreatic lipase enzymes. Providing synergistic actions for facilitating greater weight reduction, obesity control, and insulin utilization.

TABLE 27
List of ingredients of Formula 26

| Ingredient | Daily Amount per Unit Dose | |
|---|---|---|
| Allulose | 5-15 | g |
| Inulin | 4-12 | g |
| Mulberry Leaf Polyphenols | 300-900 | mg |
| Kidney bean extract | 500-1500 | mg |
| Kaempferol | 200-1000 | mg |
| Luteolin | 400-1600 | mg |
| Garlic oil extract | 240-1200 | mg |
| Quercetin | 275-750 | mg |
| Blueberry/Blackberry Anthocyanins | 0.5-2 | g |
| Diosgenin | 700-2100 | mg |
| Grape seed extract | 150-450 | mcg |
| Naringin | 300-900 | mg |
| Fucoxanthin (Seaweed) | 20-80 | mg |
| Baicalein | 400-1600 | mg |
| Chlorogenic Acid | 100-400 | mg |
| Epigallocatechin | 200-800 | mg |

Formula 27

### Formula 27

The present invention encompasses an Anti-Inflammatory, Phytochemical, Weight-Loss Formulation comprising phytochemicals, botanical extracts, non-caloric sweeteners, soluble fibers, and probiotics within the field of natural products and nutrition science. The formula is designed for facilitating weight loss, combatting obesity, and improving glycemic control as a dietary supplement or food item. The composition comprises glucagon-like peptide-1 (GLP-1) agonists, dipeptidyl peptidase-4 (DPP-4) inhibitors, and compounds that improve insulin resistance. This formulation includes a composition of anti-inflammatory compounds to inhibit cell death and inflammation within the adipose tissue, which can result in lipid spill-over, glucotoxicity, and increased insulin resistance. Providing synergistic actions for facilitating greater weight reduction, obesity control, and insulin utilization.

TABLE 28
List of ingredients of Formula 27

| Ingredient | Daily Amount per Unit Dose | |
|---|---|---|
| Allulose | 5-15 | g |
| Inulin | 4-12 | g |
| Resistant Starch | 10-30 | g |
| Berberine HCl | 1-3 | g |
| Green Tea Extract | 50-220 | mg |
| Pomegranate Extract | 300-900 | mg |
| Resveratrol | 100-300 | mg |
| Quercetin | 275-750 | mg |
| Naringenin | 300-900 | mg |
| Chromium Picolinate | 150-450 | mcg |
| Blueberry/Blackberry Anthocyanins | 0.5-1.5 | g |
| Curcuminoids | 0.75-2 | g |
| Black Seed Extract | 1-3 | g |
| Ginger Extract | 0.5-1.5 | mg |

Formula 28

### Formula 28

The present invention encompasses a Botanical Energy Drink within the field of natural products and nutrition science comprising phytochemicals, botanical extracts, and non-caloric sweeteners. The formula is designed for facilitating weight loss, combatting obesity, and improving glycemic control. The composition comprises glucagon-like peptide-1 (GLP-1) agonists, dipeptidyl peptidase-4 (DPP-4) inhibitors, and compounds that improve insulin resistance.

TABLE 29
List of ingredients of Formula 28

| Ingredient | Daily Amount | |
|---|---|---|
| Unroasted (Green) Coffee Bean Extract | 0.4-1.2 | g |
| Yerba Mate Extract | 0.4-1.2 | g |
| Camellia Sinensis Tea and Seed Extract | 2-4 | g |
| Green Tea Extract | 300-900 | mg |
| Blueberry/Blackberry Anthocyanins | 0.5-1.5 | g |
| Stevia (Rebaudioside A) | 0.35-1.2 | g |

| | |
|---|---|
| Natural Flavor | AR |

Formula 29

### Formula 29

The present invention encompasses A Fatty Acid & Botanical Extract Weight Loss formulation comprising botanical extracts, natural sweeteners, and minerals within the field of natural products and nutrition science. The formula is designed for facilitating weight loss, combatting obesity, and improving glycemic control as a dietary supplement, food item, or food additive. The composition comprises glucagon-like peptide-1 (GLP-1) agonists, dipeptidyl peptidase-4 (DPP-4) inhibitors, and compounds that improve insulin resistance.

TABLE 30
List of ingredients of Formula 29

| Ingredient | Daily Amount | |
|---|---|---|
| Agave Extract | 0.5-1 | g |
| Bitter Melon Extract | 0.4-1 | g |
| Cinnamon Extract | 0.5-1 | g |
| Oleic Acid | 10-45 | g |
| Fenugreek Extract | 0.5-1 | g |
| Vanadyl Sulfate | 50-150 | mg |
| Magnesium Aspartate | 200-500 | mg |
| Mangosteen Extract | 0.2-2 | g |

Formula 30

### Formula 30

The present invention encompasses Fatty Acid & Phytochemical Prebiotic Weight Loss formulation comprising botanical extracts, non-caloric sweeteners, minerals, and phytochemicals within the field of natural products and nutrition science. The formula is designed for facilitating weight loss, combatting obesity, and improving glycemic control as a dietary supplement, food item, or food additive. The composition comprises glucagon-like peptide-1 (GLP-1) agonists, dipeptidyl peptidase-4 (DPP-4) inhibitors, and compounds that improve insulin resistance.

TABLE 31
List of ingredients of Formula 30

| Ingredient | Daily Amount | |
|---|---|---|
| Berberine HCl | 0.5-2 | g |
| Quercetin | 200-500 | mg |
| Chromium Polynicotinate | 200-750 | mcg |
| Inulin | 4-12 | g |
| Alpha-Lipoic Acid | 150-300 | mg |
| Cinnamon Extract | 0.5-1 | g |
| Monounsaturated Acids | 10-45 | g |
| Erythritol | 5-20 | g |
| Magnesium Citrate | 200-500 | mg |

Formula 31

### Formula 31

The present invention encompasses a Rehydration, Electrolyte Replacer, Osmolarity Hydration Multiplier Drink comprising trace and macro minerals, phytochemicals, vitamins, blood buffers, nitric oxide boosters, non-caloric sweeteners, soluble fibers, and probiotics within the field of natural products and nutrition science. The formula is designed for facilitating weight loss, combatting obesity, and improving glycemic control. The composition comprises glucagon-like peptide-1 (GLP-1) agonists, dipeptidyl peptidase-4 (DPP-4) inhibitors, glucose-dependent insulinotropic polypeptide (GIP) agonists, and compounds that improve insulin resistance. 8-12 fluid ounces of cold Drink before, during, and after physical activity.

TABLE 32
List of ingredients of Formula 31

| Ingredient | Daily Amount | |
|---|---|---|
| Allulose | 5-10 | g |
| Inulin | 4-8 | g |
| Resistant Dextrin | 10-15 | g |
| Resveratrol | 100-300 | mg |
| Alpha-Lipoic Acid | 250-750 | mg |
| Blueberry/Blackberry Anthocyanins | 0.5-2 | g |
| Astaxanthin | 12 | mg |
| Black Currant Seed Extract | 300 | mg |
| Pomegranate Extract | 300-100 | mg |
| Chromium Picolinate | 150-299 | mcg |
| Naringin | 300-900 | mg |
| Sucralose | 200-800 | mg |
| Calcium (As Calcium Lactate and Gluconate) | 150 | mg |
| Phosphorous (As Calcium and Potassium Phosphate) | 60 | mg |
| Magnesium (As Magnesium Citrate) | 150 | mg |
| Chloride (As Potassium Chloride) | 225 | mg |
| Zinc (As Zinc Citrate) | 15 | mg |
| Potassium (As Potassium Citrate) | 130 | mg |
| Sodium (Sodium Citrate) | 150-350 | mg |
| Potassium (As Potassium Citrate) | 130 | mg |
| Ascorbic Acid | 40 | mg |

| | |
|---|---|
| Citric Acid | |
| Natural Flavor | AR |

Formula 32

### Formula 32

The present invention encompasses a Prebiotic, Botanical Extract, and Phytochemical formulation comprising botanical extracts, prebiotics, resistant dextrins, and phytochemicals within the field of natural products and nutrition science. The formula is designed for facilitating weight loss, combatting obesity, and improving glycemic control as a dietary supplement, food item, or food additive. The composition comprises glucagon-like peptide-1 (GLP-1) agonists, dipeptidyl peptidase-4 (DPP-4) inhibitors, and compounds that improve insulin resistance.

TABLE 33
List of ingredients of Formula 32

| Ingredient | Daily Amount | |
|---|---|---|
| Oligosaccharides | 5-15 | g |
| Resistant Dextrin | 10-20 | g |
| Mangosteen Extract | 0.5-1 | g |
| Resveratrol | 200-500 | mg |
| Green Tea Extract | 0.2-1 | g |
| Chromium Picolinate | 200-500 | mcg |

### Evaluation of the Inventive Method

The study assessed the weight reduction effects of a composition analogous to the disclosed formulation 3. The composition targets incretin hormone metabolic pathways for weight management and glycemic regulation. The study monitored over 1000 subjects, each with a Body Mass Index (BMI) ranging from 25 to 35 kg/m², averaging 28.4 kg/m².

### Study Protocol

Comprehensive baseline metrics, including demographic data, racial background, height, waist circumference, initial weight, and BMI, were collected. Subjects were monitored monthly for weight changes and any adverse effects. The regimen involved bi-daily consumption of a beverage containing endogenous glucagon-like peptide-1 (GLP-1) agonists, dipeptidyl peptidase-4 (DPP-4) inhibitors, glucose-dependent insulinotropic polypeptide (GIP) agonists, and insulin resistance-modifying compounds. This was co-administered with thermogenic activators in vegetable gel capsules. Participants adhered to a controlled-calorie, low glycemic index diet throughout the study.

### Results

The study participants demonstrated an average weight loss of 7.1 lbs and 7.3% of body weight after four weeks, with a continued variation of ±3% monthly weight over the course of the study. No significant adverse effects were reported. Notable improvements were also observed in BMI and waist circumference measurements.

### CONCLUSION

The results support the efficacy of the disclosed method, involving the administration endogenous glucagon-like peptide-1 (GLP-1) agonists, dipeptidyl peptidase-4 (DPP-4) inhibitors, glucose-dependent insulinotropic polypeptide (GIP) agonists, and agents that improve insulin resistance, and co-administering thermogenic activators, or other weight reduction classes of compounds to achieve significant weight reduction without serious adverse effects. This method may offer a notable advantage over injectable exogenous GLP-1 receptor agonist medications, which are associated with gastrointestinal side effects and a slower onset of weight loss. Furthermore, it may be useful to prevent regain of body weight after discontinuing GLP-1 RA medication.

The description of the present invention has been presented for purposes of illustration and description but is not intended to be exhaustive or limiting of the invention to the form disclosed. Many modifications and variations will be apparent to those of ordinary skill in art. The embodiment described and shown was chosen and described to best explain the principles of the invention, and the practical application, and to enable others of ordinary skill in the art to understand the invention for various embodiments with various modifications as are suited to the particular use contemplated.

While the compositions and methods have been described in terms of what are presently considered to be the most practical and preferred embodiments, it is to be understood that the disclosure need not be limited to the disclosed embodiments. It is intended to cover various modifications and similar arrangements included within the spirit and scope of the disclosure, the scope of which should be accorded the broadest interpretation to encompass all such modifications and similar structures.

While the method and agent have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures.

It should also be understood that a variety of changes may be made without departing from the essence of the disclosure. Such changes are also implicitly included in the description. They still fall within the scope of this disclosure. It should be understood that this disclosure is intended to yield a patent covering numerous aspects of the disclosure both independently and as an overall system and in both method and apparatus modes.

Further, each of the various elements of the disclosure may also be achieved in a variety of manners. This disclosure should be understood to encompass each such variation, be it a variation of an embodiment of any apparatus embodiment, a method or process embodiment, or even merely a variation of any element of these.

Particularly, it should be understood that as the disclosure relates to elements of the disclosure, the words for each element may be expressed by equivalent apparatus terms or method terms—even if only the function or result is the same.

Such equivalent, broader, or even more generic terms should be considered to be encompassed in the description of each element or action. Such terms can be substituted where desired to make explicit the implicitly broad coverage to which this disclosure is entitled.

It should be understood that all actions may be expressed as a means for taking that action or as an element that causes that action.

Similarly, each physical element disclosed should be understood to encompass a disclosure of the action which that physical element facilitates.

Any patents, publications, or other references mentioned in this application for patent are hereby incorporated by reference. In addition, as to each term used it should be understood that unless its utilization in this application is inconsistent with such interpretation, common dictionary definitions should be understood as incorporated for each term and all definitions, alternative terms, and synonyms such as contained in at least one of a standard technical dictionary recognized by artisans and the Random House Webster's Unabridged Dictionary, latest edition are hereby incorporated by reference.

Finally, all references listed in the Information Disclosure Statement or other information statement filed with the application are hereby appended and hereby incorporated by reference; however, as to each of the above, to the extent that such information or statements incorporated by reference might be considered inconsistent with the patenting of this/these disclosure(s), such statements are expressly not to be considered as made by the applicant(s).

Support should be understood to exist to the degree required under new matter laws—including but not limited to United States Patent Law 35 USC 132 or other such laws—to permit the addition of any of the various dependencies or other elements presented under one independent or concept as dependencies or elements under any other independent concept.

To the extent that insubstantial substitutes are made, to the extent that the applicant did not draft any disclosure, method, or composition so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, the use of the transitional phrase “comprising” is used to maintain the “open-end” concept interpretation. Thus, unless the context requires otherwise, it should be understood that the term “compromise” or variations such as “comprises” or “comprising”, are intended to imply the inclusion of a stated element or step or group of elements or steps but not the exclusion of any other element or step or group of elements or steps.

Such terms should be interpreted in their most expansive forms as to afford the applicant the broadest coverage legally permissible.

The description of the present invention has been presented for purposes of illustration and description but is not intended to be exhaustive or limiting of the invention to the form disclosed. Many modifications and variations will be apparent to those of ordinary skill in art. The embodiment described were chosen and described in order to best explain the principles of the invention, the practical application, and to enable others of ordinary skill in the art to understand the invention for various embodiments with various modifications as are suited to the particular use contemplated.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A composition for a dietary supplement or a food product, designed for weight loss and glucose management, for use in humans and animals, the composition comprising:
a GLP-1 agonist; and
a DPP-4 inhibitor,
wherein the composition is formulated as a dosage form for oral administration.

2. The composition of claim 1, wherein the composition further comprises a compound to improve insulin resistance.

3. The composition of claim 1, wherein the dosage form is in a powder form and is configured to be formulated for dissolution in water or another liquid before oral administration.

4. The composition of claim 1, wherein the dosage form is for oral administration in a form of a powder, granule, tablet, capsule, wafer, liquid, gel, or a food item.

5. The composition of claim 1, wherein the dosage form is an emulsion, nanoemulsion, microemulsion, nano-dimensional structure, or a self-emulsifying delivery system.

6. The composition of claim 1, wherein the composition comprises one or more ingredients selected from a group consisting of fibers, botanicals, phytochemicals, sweeteners, prebiotics, probiotics, peptides, proteins, amino acids, fatty acids, nutraceuticals, Resistant starches, vitamins, and minerals.

7. The composition of claim 1, wherein the dosage form is formulated for administration as a liquid, fluid, solution, or emulsion.

8. The composition of claim 1, with the dosage form is formulated as a gel, hydrogel, or nano-dimensional gel.

9. The composition of claim 1, wherein the dosage form is formulated as a nano-dimensional structure, nanoparticle, liposome, or micelle.

10. The composition of claim 1, wherein the dosage form is formulated as a protein powder blend for oral administration.

11. The composition of claim 1, wherein the dosage form is formulated as a fiber blend.

12. The composition of claim 1, wherein the dosage form is formulated for administration in food form.

13. The composition of claim 1, wherein the composition is a food additive.

14. The composition of claim 1, wherein the composition is a medicinal food.

15. The composition of claim 1, wherein the dosage form is formulated as a powder for oral administration.

16. The composition of claim 1, wherein the composition is configured to enhance endogenous GLP-1 secretion in humans.

17. The composition of claim 1, wherein the composition is configured to increase plasma GLP-1 levels.

18. The composition according to claim 1, wherein the dosage form is formulated to prevent adverse effects in the gastrointestinal tract associated with the use of GLP-1 agonists.

19. The composition of claim 1, wherein the dosage form is formulated to prevent nausea, vomiting, or diarrhea associated with the use of GLP-1 agonists.

20. The composition of claim 1, wherein the composition is configured to reduce body weight.

21. The composition of claim 1, wherein the composition is configured to decrease body fat content.

22. The composition of claim 1, wherein the composition is configured to reduce body weight within four weeks of use.

23. The composition of claim 1, wherein the composition is configured to reduce hunger or increase the feeling of satiety.

24. The composition of claim 1, wherein the composition is configured to enhance satiety feelings.

25. The composition of claim 1, wherein the composition is configured to delay gastric emptying.

26. The composition of claim 1, wherein the composition is configured to lower the body-mass index (BMI).

27. The composition of claim 2, wherein the composition is configured to reduce blood glucose levels.

28. The composition of claim 1, wherein the composition further comprises at least one natural agonist of Glucose-dependent insulinotropic polypeptide (GIP).

29. The composition of claim 1, wherein the composition is for coadministration with a composition containing at least one agonist of glucose-dependent insulinotropic polypeptide (GIP) selected from a group consisting of sucralose, Camellia sinensis seed saponins, chlorogenic acid, and whey protein.

30. The composition of claim 1, wherein the composition is for co-administration with at least one thermogenesis activator compound selected from a group consisting of caffeine, capsaicin, epigallocatechin gallate (EGCG), forskolin, cinnamaldehyde, chlorogenic acid, naringenin, fucoxanthin, cocoa bean extracts, synephrine, piperine, and berberine, wherein the at least one thermogenesis activator is known to enhance thermogenesis in brown adipose tissue (BAT) or white adipose tissue (WAT).

31. The composition of claim 1, wherein the composition further comprises at least one thermogenesis activator compound.

32. The composition of claim 1, wherein the composition is formulated for co-administration with compounds that decrease leptin resistance in the form of dietary supplements and food items.

33. The composition of claim 1, wherein the composition further comprises at least one compound that decreases leptin resistance.

34. The composition of claim 1, wherein the composition is for co-administration with compounds that suppress ghrelin levels in the form of dietary supplements and food items.

35. The composition of claim 1, wherein the composition further comprises at least one compound that suppresses ghrelin levels.

36. The composition of claim 1, wherein the dosage form is configured to prevent weight regain after discontinuing GLP-1 RA medication.

37. The composition of claim 1, wherein the composition is configured to prevent and treat obesity in dogs, cats, and animals.

38. The composition of claim 1, wherein the composition is formulated to treat overweight dogs, cats, and animals.

39. A composition for a dietary supplement or food item comprising:
a GLP-1 agonist; and
a compound to improve insulin resistance,
wherein the composition is formulated as a powder dosage form for oral administration.

40. A method for reducing obesity and for glycemic control in humans and animals, the method comprising:
formulating a dosage form for oral administration in the form of a food product or nutritional supplement, wherein the dosage form comprises a composition comprising:
a GLP-1 agonist; and
a DPP-4 inhibitor.
